(19) United States
(12) Patent Application Publication
(10) Pub. No.: US 2003/0164794 A1
(43) Pub. Date: Sep. 4, 2003

(54) Over the horizon communications network and method

(75) Inventors: Leonard S. Haynes, Rockville, MD (US); Renato Levy, Gaithersburg, MD (US); Benjamin Bachrach, Bethesda, MD (US)

Correspondence Address: WILLIAM J. TUCKER, 8650 SOUTHWESTERN BLVD. #2825, DALLAS, TX, 75206, US

(73) Assignee: Time Domain Corporation

(21) Appl. No.: 10/090,390

(22) Filed: Mar. 4, 2002

(51) Int. Cl. H04B 7/185

(52) U.S. Cl. 342/353

(57) ABSTRACT

A network and method are provided that utilize impulse radio technology to enable an impulse radio communication link between a ground control station and an unmanned ground vehicle. Moreover, the network can include one or more unmanned aerial vehicles that act as repeater platforms which can extend the range of the impulse radio communication link between the ground control station and the unmanned ground vehicle.

### FEDERALLY SPONSORED RESEARCH AND DEVELOPMENT

This invention was made in part with government support under Contract No. DAAH01-00-C-R082 awarded by the U.S. Army Aviation and Missile Command. The federal government has certain rights in this invention.

### BACKGROUND OF THE INVENTION

1. Field of the Invention

The present invention relates in general to the communications field and, in particular, to a network and method capable of enabling a reliable radio communications link between a ground control station and one or more unmanned ground vehicles.

2. Description of Related Art

Providing reliable communications is one of the largest unsolved problems in the wireless industry. Traditional wireless communication technologies such as narrow-band RF technology suffer from problematical dead zones and multipath cancellation both of which can interfere with communications between a receiver and transmitter. In addition, traditional wireless communication technologies also suffer from a wide variety of undesirable characteristics including, for example, a limited range, a limited data rate, a limited spectral bandwidth and a shared broadcast medium. These undesirable characteristics of traditional wireless communication technologies are even more pronounced in military applications which require a very robust wireless communications network. Military applications require a robust wireless communications network that not only addresses the aforementioned shortcomings of traditional wireless technology but also ensures that there is a secure communications link which has a low probability of detection, is resistant to jamming and interference, and is also reliable in urban, forested and complex littoral environments. Accordingly, there is a need for a wireless technology that can address the specialized needs of military applications. One such military application that needs a very robust wireless communications network is a non line-of-site application where a ground control station can communicate with and possibly control one or more unmanned ground vehicles. These needs and other needs are satisfied by the network and method of the present invention.

### BRIEF DESCRIPTION OF THE INVENTION

The present invention includes a network and method that utilizes impulse radio technology to enable an impulse radio communication link between a ground control station and an unmanned ground vehicle. Moreover, the network can include one or more unmanned aerial vehicles that act as repeater platforms which can extend the range of the impulse radio communication link between the ground control station and the unmanned ground vehicle.

### BRIEF DESCRIPTION OF THE DRAWINGS

A more complete understanding of the present invention may be had by reference to the following detailed description when taken in conjunction with the accompanying drawings wherein:

FIG. 1A illustrates a representative Gaussian Monocycle waveform in the time domain;

FIG. 1B illustrates the frequency domain amplitude of the Gaussian Monocycle of FIG. 1A;

FIG. 1C represents the second derivative of the Gaussian Monocycle of FIG. 1A;

FIG. 1D represents the third derivative of the Gaussian Monocycle of FIG. 1A;

FIG. 1E represents the Correlator Output vs. the Relative Delay in a real data pulse;

FIG. 1F graphically depicts the frequency plot of the Gaussian family of the Gaussian Pulse and the first, second, and third derivative.

FIG. 2A illustrates a pulse train comprising pulses as in FIG. 1A;

FIG. 2B illustrates the frequency domain amplitude of the waveform of FIG. 2A;

FIG. 2C illustrates the pulse train spectrum;

FIG. 2D is a plot of the Frequency vs. Energy Plot and points out the coded signal energy spikes;

FIG. 3 illustrates the cross-correlation of two codes graphically as Coincidences vs. Time Offset;

FIGS. 4A-4E graphically illustrate five modulation techniques to include: Early-Late Modulation; One of Many Modulation; Flip Modulation; Quad Flip Modulation; and Vector Modulation;

FIG. 5A illustrates representative signals of an interfering signal, a coded received pulse train and a coded reference pulse train;

FIG. 5B depicts a typical geometrical configuration giving rise to multipath received signals;

FIG. 5C illustrates exemplary multipath signals in the time domain;

FIGS. 5D-5F illustrate a signal plot of various multipath environments.

FIG. 5G illustrates the Rayleigh fading curve associated with non-impulse radio transmissions in a multipath environment.

FIG. 5H illustrates a plurality of multipaths with a plurality of reflectors from a transmitter to a receiver.

FIG. 5I graphically represents signal strength as volts vs. time in a direct path and multipath environment.

FIG. 6 illustrates a representative impulse radio transmitter functional diagram;

FIG. 7 illustrates a representative impulse radio receiver functional diagram;

FIG. 8A illustrates a representative received pulse signal at the input to the correlator;

FIG. 8B illustrates a sequence of representative impulse signals in the correlation process;

FIG. 8C illustrates the output of the correlator for each of the time offsets of FIG. 8B.

FIG. 9 is a diagram illustrating the basic components of a network in accordance with the present invention.

FIGS. 10A and 10B are diagrams of two exemplary unmanned ground vehicles that can be used in the network of FIG. 9.

FIG. 11 is a diagram illustrating a network that uses at least one unmanned aerial vehicle to extend the range of an impulse radio communications link between an unmanned ground vehicle and a ground control station.

FIGS. 12A and 12B are diagrams of two exemplary unmanned aerial vehicles that can be used in the network of FIG. 11.

FIG. 13 is a graph that shows a simulated example of the air-to-air and air-to-ground cost functions that can be used in a first embodiment of a self-controlling method used to control the unmanned aerial vehicles.

FIGS. 14-17 are illustrated graphs of different scenarios for controlling the unmanned aerial vehicles in accordance with the first embodiment of the self-controlling method.

FIG. 18 is a flowchart illustrating the basic steps of a preferred method for enabling an impulse radio communication link between an unmanned ground vehicle and a ground control station in accordance with the present invention.

### DETAILED DESCRIPTION OF THE INVENTION

The present invention includes a network and method that are capable of enabling a reliable radio communications link between a ground control station and one or more unmanned ground vehicles that are deployed out-of-the sight of the ground control station. This ability to have a reliable communications link between a ground control station and an unmanned ground control vehicle is a significant improvement over the state-of-art. This significant improvement over the state-of-art is attributable, in part, to the use of the emerging and revolutionary ultra wideband technology (UWB) called impulse radio communication technology (also known as impulse radio).

Impulse radio has been described in a series of patents, including U.S. Pat. Nos. 4,641,317 (issued Feb. 3, 1987), 4,813,057 (issued Mar. 14, 1989), 4,979,186 (issued Dec. 18, 1990) and 5,363,108 (issued Nov. 8, 1994) to Larry W. Fullerton. A second generation of impulse radio patents includes U.S. Pat. Nos. 5,677,927 (issued Oct. 14, 1997), 5,687,169 (issued Nov. 11, 1997), 5,764,696 (issued Jun. 9, 1998), and 5,832,035 (issued Nov. 3, 1998) to Fullerton et al.

Uses of impulse radio systems are described in U.S. patent application Ser. No. 09/332,502, titled, “System and Method for Intrusion Detection using a Time Domain Radar Array,” and U.S. patent application Ser. No. 09/332,503, titled, “Wide Area Time Domain Radar Array,” both filed on Jun. 14, 1999, and both of which are assigned to the assignee of the present invention. The above patent documents are incorporated herein by reference.

This section provides an overview of impulse radio technology and relevant aspects of communications theory. It is provided to assist the reader with understanding the present invention and should not be used to limit the scope of the present invention. It should be understood that the terminology ‘impulse radio’ is used primarily for historical convenience and that the terminology can be generally interchanged with the terminology ‘impulse communications system, ultra-wideband system, or ultra-wideband communication systems’. Furthermore, it should be understood that the described impulse radio technology is generally applicable to various other impulse system applications including but not limited to impulse radar systems and impulse positioning systems. Accordingly, the terminology ‘impulse radio’ can be generally interchanged with the terminology ‘impulse transmission system and impulse reception system.’

Impulse radio refers to a radio system based on short, low duty-cycle pulses. An ideal impulse radio waveform is a short Gaussian monocycle. As the name suggests, this waveform attempts to approach one cycle of radio frequency (RF) energy at a desired center frequency. Due to implementation and other spectral limitations, this waveform may be altered significantly in practice for a given application. Many waveforms having very broad, or wide, spectral bandwidth approximate a Gaussian shape to a useful degree.

Impulse radio can use many types of modulation, including amplitude modulation, phase modulation, frequency modulation, time-shift modulation (also referred to as pulse-position modulation or pulse-interval modulation) and M-ary versions of these. In this document, the time-shift modulation method is often used as an illustrative example. However, someone skilled in the art will recognize that alternative modulation approaches may, in some instances, be used instead of or in combination with the time-shift modulation approach.

In impulse radio communications, inter-pulse spacing may be held constant or may be varied on a pulse-by-pulse basis by information, a code, or both. Generally, conventional spread spectrum systems employ codes to spread the normally narrow band information signal over a relatively wide band of frequencies. A conventional spread spectrum receiver correlates these signals to retrieve the original information signal. In impulse radio communications, codes are not typically used for energy spreading because the monocycle pulses themselves have an inherently wide bandwidth. Codes are more commonly used for channelization, energy smoothing in the frequency domain, resistance to interference, and reducing the interference potential to nearby receivers. Such codes are commonly referred to as time-hopping codes or pseudo-noise (PN) codes since their use typically causes inter-pulse spacing to have a seemingly random nature. PN codes may be generated by techniques other than pseudorandom code generation. Additionally, pulse trains having constant, or uniform, pulse spacing are commonly referred to as uncoded pulse trains. A pulse train with uniform pulse spacing, however, may be described by a code that specifies non-temporal, i.e., non-time related, pulse characteristics.

In impulse radio communications utilizing time-shift modulation, information comprising one or more bits of data typically time-position modulates a sequence of pulses. This yields a modulated, coded timing signal that comprises a train of pulses from which a typical impulse radio receiver employing the same code may demodulate and, if necessary, coherently integrate pulses to recover the transmitted information.

The impulse radio receiver is typically a direct conversion receiver with a cross correlator front-end that coherently converts an electromagnetic pulse train of monocycle pulses to a baseband signal in a single stage. The baseband signal is the basic information signal for the impulse radio communications system. A subcarrier may also be included with the baseband signal to reduce the effects of amplifier drift and low frequency noise. Typically, the subcarrier alternately reverses modulation according to a known pattern at a rate faster than the data rate. This same pattern is used to reverse the process and restore the original data pattern just before detection. This method permits alternating current (AC) coupling of stages, or equivalent signal processing, to eliminate direct current (DC) drift and errors from the detection process. This method is described in more detail in U.S. Pat. No. 5,677,927 to Fullerton et al.

Waveforms

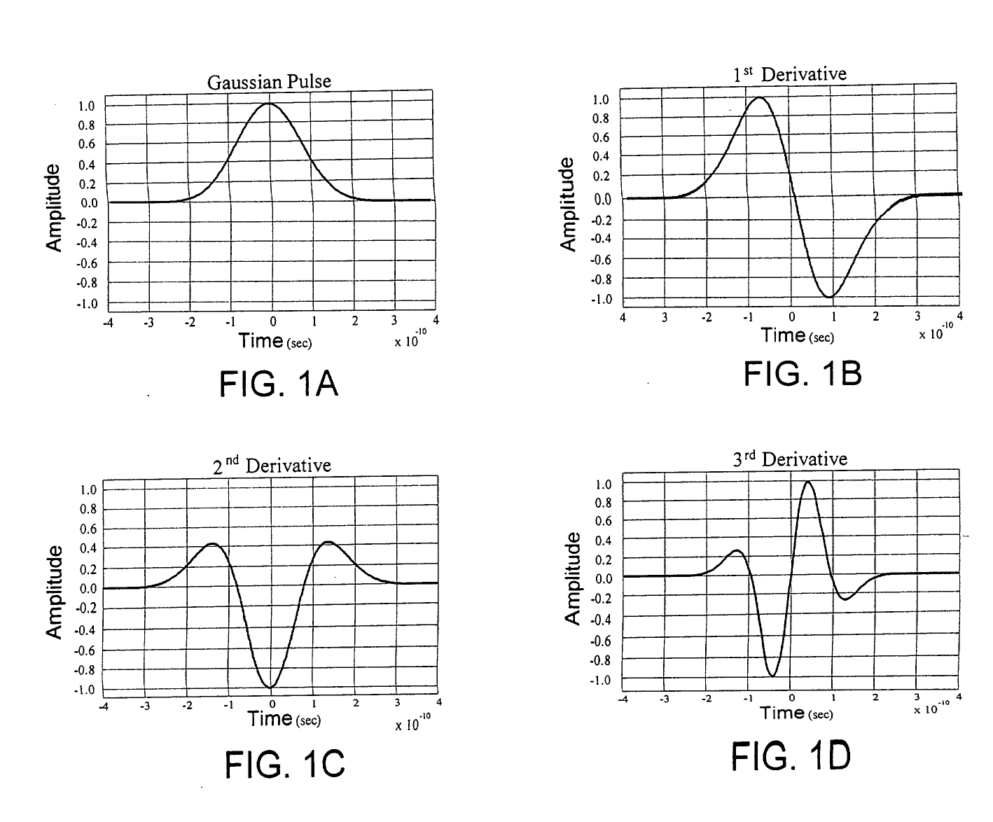

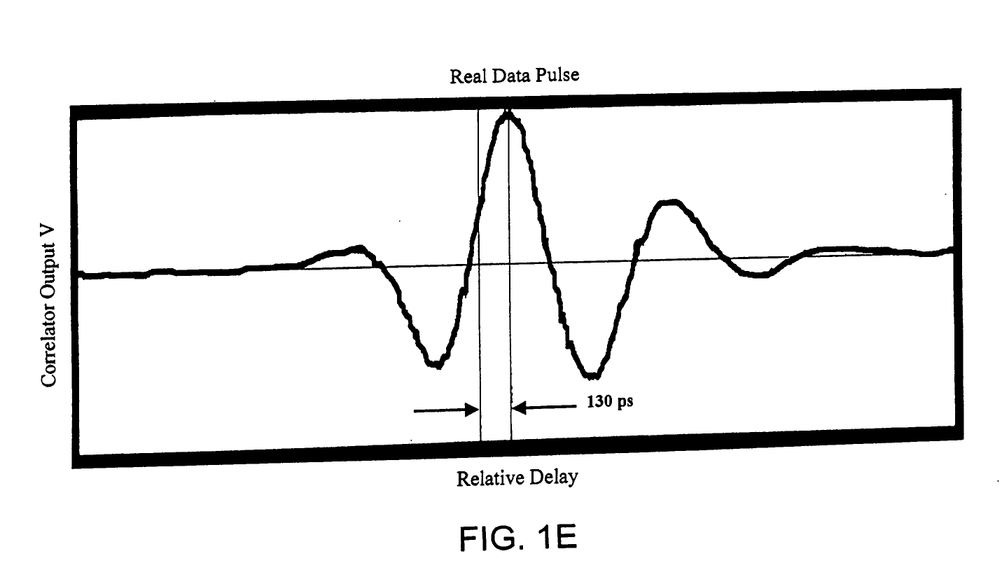

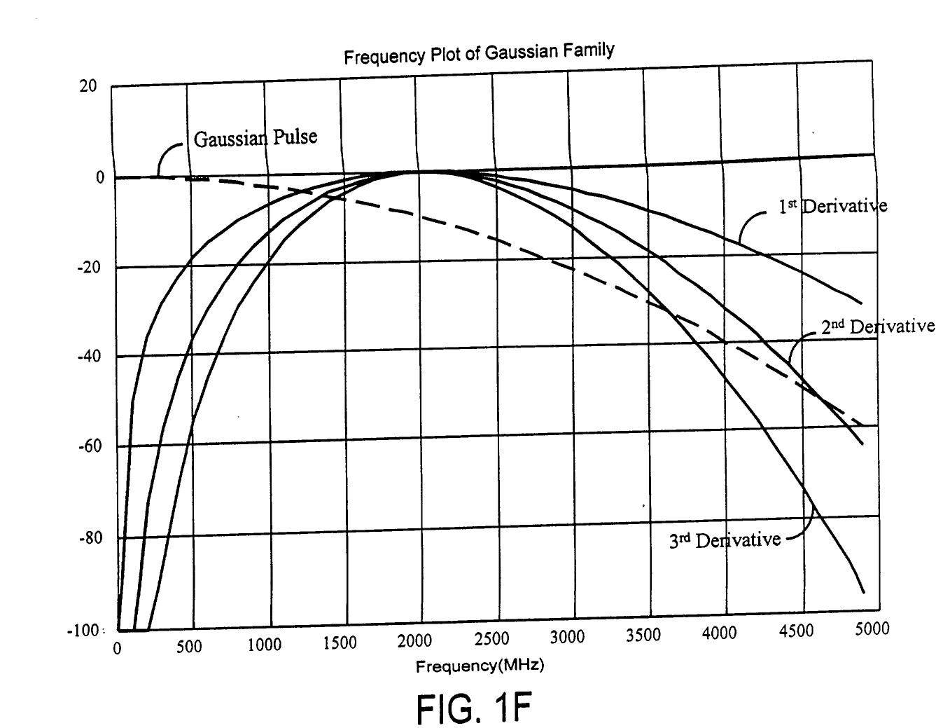

Impulse transmission systems are based on short, low duty-cycle pulses. Different pulse waveforms, or pulse types, may be employed to accommodate requirements of various applications. Typical pulse types include a Gaussian pulse, pulse doublet (also referred to as a Gaussian monocycle), pulse triplet, and pulse quadlet as depicted in FIGS. 1A through 1D, respectively. An actual received waveform that closely resembles the theoretical pulse quadlet is shown in FIG. 1E. A pulse type may also be a wavelet set produced by combining two or more pulse waveforms (e.g., a doublet/triplet wavelet set). These different pulse types may be produced by methods described in the patent documents referenced above or by other methods, as persons skilled in the art would understand.

For analysis purposes, it is convenient to model pulse waveforms in an ideal manner. For example, the transmitted waveform produced by supplying a step function into an ultra-wideband antenna may be modeled as a Gaussian monocycle. A Gaussian monocycle (normalized to a peak value of 1) may be described by

$${f}_{mono} ( t ) = \sqrt{e} ( \frac{t}{σ} ) {ⅇ}^{\frac{- {t}^{2}}{2 {σ}^{2}}}$$

where σ is a time scaling parameter, t is time, and e is the natural logarithm base.

The power spectral density of the Gaussian monocycle is shown in FIG. 1F, along with spectrums for the Gaussian pulse, triplet, and quadlet. The corresponding equation for the Gaussian monocycle is:

$${F}_{mono} ( f ) = {( 2 π )}^{\frac{3}{2}} σ f {ⅇ}^{- 2 {( π σ f )}^{2}}$$

The center frequency (f_{c}), or frequency of peak spectral density, of the Gaussian monocycle is:

$${f}_{c} = \frac{1}{2 πσ}$$

It should be noted that the output of an ultra-wideband antenna is essentially equal to the derivative of its input. Accordingly, since the pulse doublet, pulse triplet, and pulse quadlet are the first, second, and third derivatives of the Gaussian pulse, in an ideal model, an antenna receiving a Gaussian pulse will transmit a Gaussian monocycle and an antenna receiving a Gaussian monocycle will provide a pulse triplet.

Pulse Trains

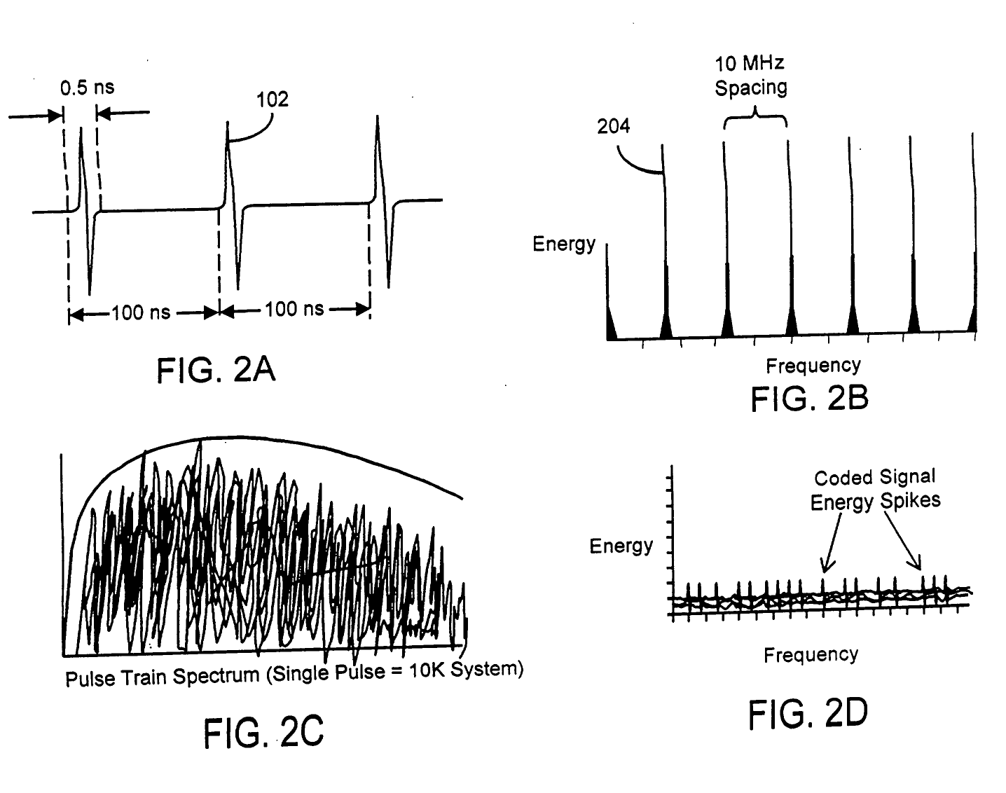

Impulse transmission systems may communicate one or more data bits with a single pulse; however, typically each data bit is communicated using a sequence of pulses, known as a pulse train. As described in detail in the following example system, the impulse radio transmitter produces and outputs a train of pulses for each bit of information. FIGS. 2A and 2B are illustrations of the output of a typical 10 megapulses per second (Mpps) system with uncoded, unmodulated pulses, each having a width of 0.5 nanoseconds (ns). FIG. 2A shows a time domain representation of the pulse train output. FIG. 2B illustrates that the result of the pulse train in the frequency domain is to produce a spectrum comprising a set of comb lines spaced at the frequency of the 10 Mpps pulse repetition rate. When the full spectrum is shown, as in FIG. 2C, the envelope of the comb line spectrum corresponds to the curve of the single Gaussian monocycle spectrum in FIG. 1F. For this simple uncoded case, the power of the pulse train is spread among roughly two hundred comb lines. Each comb line thus has a small fraction of the total power and presents much less of an interference problem to a receiver sharing the band. It can also be observed from FIG. 2A that impulse transmission systems typically have very low average duty cycles, resulting in average power lower than peak power. The duty cycle of the signal in FIG. 2A is 0.5%, based on a 0.5 ns pulse duration in a 100 ns interval.

The signal of an uncoded, unmodulated pulse train may be expressed:

$$s ( t ) = {( - 1 )}^{f} a {\sum }_{j}^{} ω ( ct - {jT}_{f} , b )$$

where j is the index of a pulse within a pulse train, (−1)^{f} is polarity (+/−), a is pulse amplitude, b is pulse type, c is pulse width, ω(t,b) is the normalized pulse waveform, and T_{f} is pulse repetition time.

The energy spectrum of a pulse train signal over a frequency bandwidth of interest may be determined by summing the phasors of the pulses at each frequency, using the following equation:

$$A ( ω ) = \vert {\sum }_{i = 1}^{n} \frac{{ⅇ}^{jΔ t}}{n} \vert$$

where A(ω) is the amplitude of the spectral response at a given frequency, ω is the frequency being analyzed (2πf), Δt is the relative time delay of each pulse from the start of time period, and n is the total number of pulses in the pulse train.

A pulse train can also be characterized by its autocorrelation and cross-correlation properties. Autocorrelation properties pertain to the number of pulse coincidences (i.e., simultaneous arrival of pulses) that occur when a pulse train is correlated against an instance of itself that is offset in time. Of primary importance is the ratio of the number of pulses in the pulse train to the maximum number of coincidences that occur for any time offset across the period of the pulse train. This ratio is commonly referred to as the main-lobe-to-side-lobe ratio, where the greater the ratio, the easier it is to acquire and field a signal.

Cross-correlation properties involve the potential for pulses from two different signals simultaneously arriving, or coinciding, at a receiver. Of primary importance are the maximum and average numbers of pulse coincidences that may occur between two pulse trains. As the number of coincidences increases, the propensity for data errors increases. Accordingly, pulse train cross-correlation properties are used in determining channelization capabilities of impulse transmission systems (i.e., the ability to simultaneously operate within close proximity).

Coding

Specialized coding techniques can be employed to specify temporal and/or non-temporal pulse characteristics to produce a pulse train having certain spectral and/or correlation properties. For example, by employing a PN code to vary inter-pulse spacing, the energy in the comb lines presented in FIG. 2B can be distributed to other frequencies as depicted in FIG. 2D, thereby decreasing the peak spectral density within a bandwidth of interest. Note that the spectrum retains certain properties that depend on the specific (temporal) PN code used. Spectral properties can be similarly affected by using non-temporal coding (e.g., inverting certain pulses).

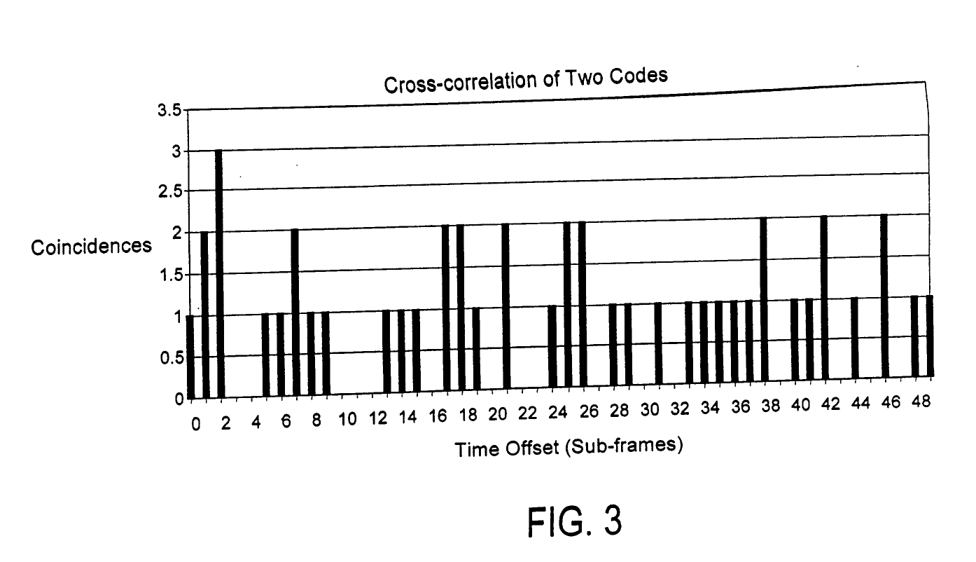

Coding provides a method of establishing independent communication channels. Specifically, families of codes can be designed such that the number of pulse coincidences between pulse trains produced by any two codes will be minimal. For example, FIG. 3 depicts cross-correlation properties of two codes that have no more than four coincidences for any time offset. Generally, keeping the number of pulse collisions minimal represents a substantial attenuation of the unwanted signal.

Coding can also be used to facilitate signal acquisition. For example, coding techniques can be used to produce pulse trains with a desirable main-lobe-to-side-lobe ratio. In addition, coding can be used to reduce acquisition algorithm search space.

Coding methods for specifying temporal and non-temporal pulse characteristics are described in commonly owned, co-pending applications titled “A Method and Apparatus for Positioning Pulses in Time,” application Ser. No. 09/592,249, and “A Method for Specifying Non-Temporal Pulse Characteristics,” application Ser. No. 09/592,250, both filed Jun. 12, 2000, and both of which are incorporated herein by reference.

Typically, a code consists of a number of code elements having integer or floating-point values. A code element value may specify a single pulse characteristic or may be subdivided into multiple components, each specifying a different pulse characteristic. Code element or code component values typically map to a pulse characteristic value layout that may be fixed or non-fixed and may involve value ranges, discrete values, or a combination of value ranges and discrete values. A value range layout specifies a range of values that is divided into components that are each subdivided into subcomponents, which can be further subdivided, as desired. In contrast, a discrete value layout involves uniformly or non-uniformly distributed discrete values. A non-fixed layout (also referred to as a delta layout) involves delta values relative to some reference value. Fixed and non-fixed layouts, and approaches for mapping code element/component values, are described in co-owned, co-pending applications, titled “Method for Specifying Pulse Characteristics using Codes,” application Ser. No. 09/592,290 and “A Method and Apparatus for Mapping Pulses to a Non-Fixed Layout,” application Ser. No. 09/591,691, both filed on Jun. 12, 2000, both of which are incorporated herein by reference.

A fixed or non-fixed characteristic value layout may include a non-allowable region within which a pulse characteristic value is disallowed. A method for specifying non-allowable regions is described in co-owned, co-pending application titled “A Method for Specifying Non-Allowable Pulse Characteristics,” application Ser. No. 09/592,289, filed Jun. 12, 2000, and incorporated herein by reference. A related method that conditionally positions pulses depending on whether code elements map to non-allowable regions is described in co-owned, co-pending application, titled “A Method and Apparatus for Positioning Pulses Using a Layout having Non-Allowable Regions,” application Ser. No. 09/592,248 filed Jun. 12, 2000, and incorporated herein by reference.

The signal of a coded pulse train can be generally expressed by:

$${s}_{tr}^{( k )} ( t ) = {\sum }_{j}^{} {( - 1 )}^{{f}_{j}^{( k )}} {a}_{j}^{( k )} ω ( {c}_{j}^{( k )} t - {T}_{j}^{( k )} , {b}_{j}^{( k )} )$$

where k is the index of a transmitter, j is the index of a pulse within its pulse train, (−1)fⱼ^{(k)}, aⱼ^{(k)}, bⱼ^{(k)}, cⱼ^{(k)}, and ω(t,bⱼ ^{(k)}) are the coded polarity, pulse amplitude, pulse type, pulse width, and normalized pulse waveform of the jth pulse of the kth transmitter, and Tⱼ^{(k)} is the coded time shift of the jth pulse of the kth transmitter. Note: When a given non-temporal characteristic does not vary (i.e., remains constant for all pulses), it becomes a constant in front of the summation sign.

Various numerical code generation methods can be employed to produce codes having certain correlation and spectral properties. Such codes typically fall into one of two categories: designed codes and pseudorandom codes. A designed code may be generated using a quadratic congruential, hyperbolic congruential, linear congruential, Costas array, or other such numerical code generation technique designed to generate codes having certain correlation properties. A pseudorandom code may be generated using a computer's random number generator, binary shift-register(s) mapped to binary words, a chaotic code generation scheme, or the like. Such ‘random-like’ codes are attractive for certain applications since they tend to spread spectral energy over multiple frequencies while having ‘good enough’ correlation properties, whereas designed codes may have superior correlation properties but possess less suitable spectral properties. Detailed descriptions of numerical code generation techniques are included in a co-owned, co-pending patent application titled “A Method and Apparatus for Positioning Pulses in Time,” application Ser. No. 09/592,248, filed Jun. 12, 2000, and incorporated herein by reference.

It may be necessary to apply predefined criteria to determine whether a generated code, code family, or a subset of a code is acceptable for use with a given UWB application. Criteria may include correlation properties, spectral properties, code length, non-allowable regions, number of code family members, or other pulse characteristics. A method for applying predefined criteria to codes is described in co-owned, co-pending application, titled “A Method and Apparatus for Specifying Pulse Characteristics using a Code that Satisfies Predefined Criteria,” application Ser. No. 09/592,288, filed Jun. 12, 2000, and incorporated herein by reference.

In some applications, it may be desirable to employ a combination of codes. Codes may be combined sequentially, nested, or sequentially nested, and code combinations may be repeated. Sequential code combinations typically involve switching from one code to the next after the occurrence of some event and may also be used to support multicast communications. Nested code combinations may be employed to produce pulse trains having desirable correlation and spectral properties. For example, a designed code may be used to specify value range components within a layout and a nested pseudorandom code may be used to randomly position pulses within the value range components. With this approach, correlation properties of the designed code are maintained since the pulse positions specified by the nested code reside within the value range components specified by the designed code, while the random positioning of the pulses within the components results in particular spectral properties. A method for applying code combinations is described in co-owned, co-pending application, titled “A Method and Apparatus for Applying Codes Having Pre-Defined Properties,” application Ser. No. 09/591,690, filed Jun. 12, 2000, and incorporated herein by reference.

Modulation

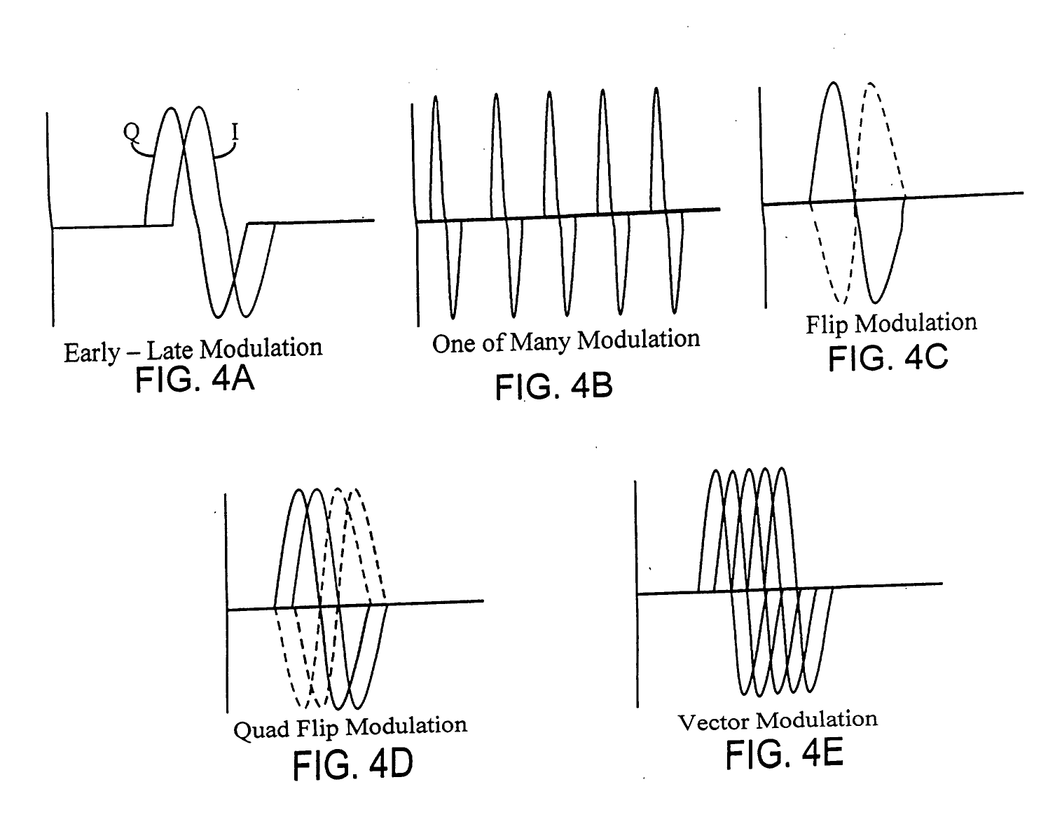

Various aspects of a pulse waveform may be modulated to convey information and to further minimize structure in the resulting spectrum. Amplitude modulation, phase modulation, frequency modulation, time-shift modulation and M-ary versions of these were proposed in U.S. Pat. No. 5,677,927 to Fullerton et al., previously incorporated by reference. Time-shift modulation can be described as shifting the position of a pulse either forward or backward in time relative to a nominal coded (or uncoded) time position in response to an information signal. Thus, each pulse in a train of pulses is typically delayed a different amount from its respective time base clock position by an individual code delay amount plus a modulation time shift. This modulation time shift is normally very small relative to the code shift. In a 10 Mpps system with a center frequency of 2 GHz, for example, the code may command pulse position variations over a range of 100 ns, whereas, the information modulation may shift the pulse position by 150 ps. This two-state ‘early-late’ form of time shift modulation is depicted in FIG. 4A.

A pulse train with conventional ‘early-late’ time-shift modulation can be expressed:

$${s}_{tr}^{( k )} ( t ) = {\sum }_{j}^{} {( - 1 )}^{{f}_{j}^{( k )}} {a}_{j}^{( k )} ω ( {c}_{j}^{( k )} t - {T}_{j}^{( k )} - δ {d}_{[ j / {N}_{s} ]}^{( k )} , {b}_{j}^{( k )} )$$

where k is the index of a transmitter, j is the index of a pulse within its pulse train, (−1)fⱼ^{(k)}, aⱼ^{(k)}, bⱼ^{(k)}, cⱼ^{(k)}, and ω(t,bⱼ^{(k)}) are the coded polarity, pulse amplitude, pulse type, pulse width, and normalized pulse waveform of the jth pulse of the kth transmitter, Tⱼ^{(k)} is the coded time shift of the jth pulse of the kth transmitter, δ is the time shift added when the transmitted symbol is 1 (instead of 0), d^{(k)} is the data (i.e., 0 or 1) transmitted by the kth transmitter, and Nₛ is the number of pulses per symbol (e.g., bit). Similar expressions can be derived to accommodate other proposed forms of modulation.

An alternative form of time-shift modulation can be described as One-of-Many Position Modulation (OMPM). The OMPM approach, shown in FIG. 4B, involves shifting a pulse to one of N possible modulation positions about a nominal coded (or uncoded) time position in response to an information signal, where N represents the number of possible states. For example, if N were four (4), two data bits of information could be conveyed. For further details regarding OMPM, see “Apparatus, System and Method for One-of-Many Position Modulation in an Impulse Radio Communication System,” Attorney Docket No. 1659.0860000, filed Jun. 7, 2000, assigned to the assignee of the present invention, and incorporated herein by reference.

An impulse radio communications system can employ flip modulation techniques to convey information. The simplest flip modulation technique involves transmission of a pulse or an inverted (or flipped) pulse to represent a data bit of information, as depicted in FIG. 4C. Flip modulation techniques may also be combined with time-shift modulation techniques to create two, four, or more different data states. One such flip with shift modulation technique is referred to as Quadrature Flip Time Modulation (QFTM). The QFTM approach is illustrated in FIG. 4D. Flip modulation techniques are further described in patent application titled “Apparatus, System and Method for Flip Modulation in an Impulse Radio Communication System,” application Ser. No. 09/537,692, filed Mar. 29, 2000, assigned to the assignee of the present invention, and incorporated herein by reference.

Vector modulation techniques may also be used to convey information. Vector modulation includes the steps of generating and transmitting a series of time-modulated pulses, each pulse delayed by one of at least four pre-determined time delay periods and representative of at least two data bits of information, and receiving and demodulating the series of time-modulated pulses to estimate the data bits associated with each pulse. Vector modulation is shown in FIG. 4E. Vector modulation techniques are further described in patent application titled “Vector Modulation System and Method for Wideband Impulse Radio Communications,” application Ser. No. 09/169,765, filed Dec. 9, 1999, assigned to the assignee of the present invention, and incorporated herein by reference.

Reception and Demodulation

Impulse radio systems operating within close proximity to each other may cause mutual interference. While coding minimizes mutual interference, the probability of pulse collisions increases as the number of coexisting impulse radio systems rises. Additionally, various other signals may be present that cause interference. Impulse radios can operate in the presence of mutual interference and other interfering signals, in part because they do not depend on receiving every transmitted pulse. Impulse radio receivers perform a correlating, synchronous receiving function (at the RF level) that uses statistical sampling and combining, or integration, of many pulses to recover transmitted information. Typically, 1 to 1000 or more pulses are integrated to yield a single data bit thus diminishing the impact of individual pulse collisions, where the number of pulses that must be integrated to successfully recover transmitted information depends on a number of variables including pulse rate, bit rate, range and interference levels.

Interference Resistance

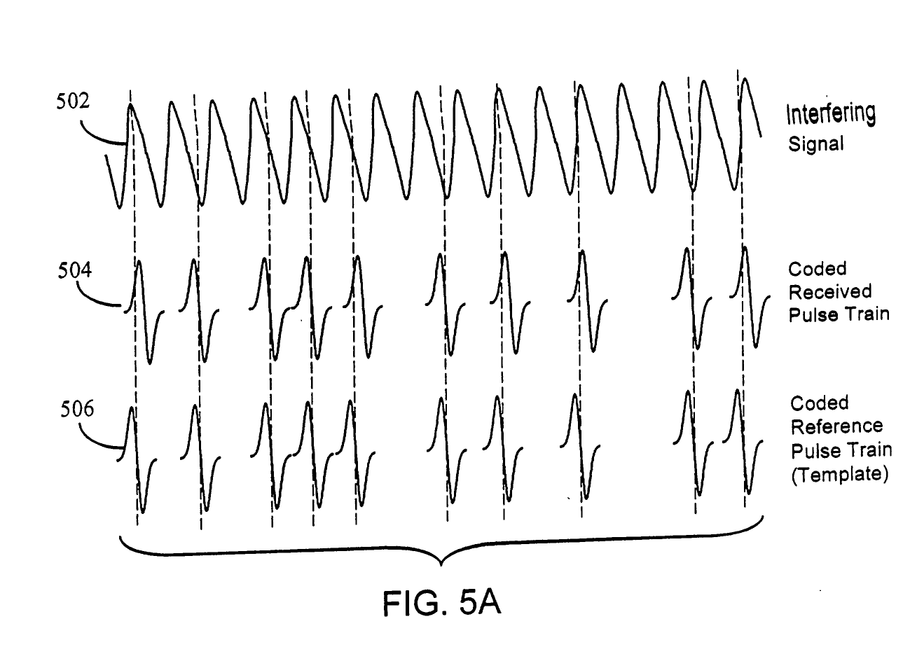

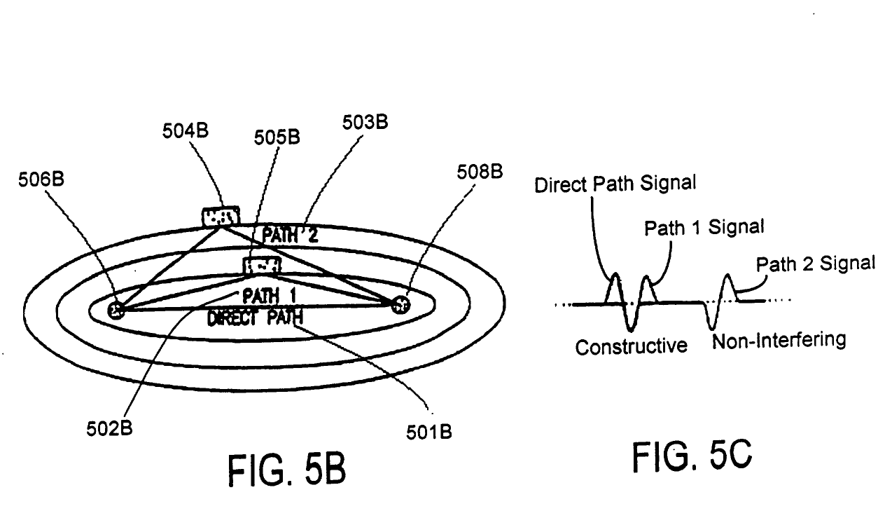

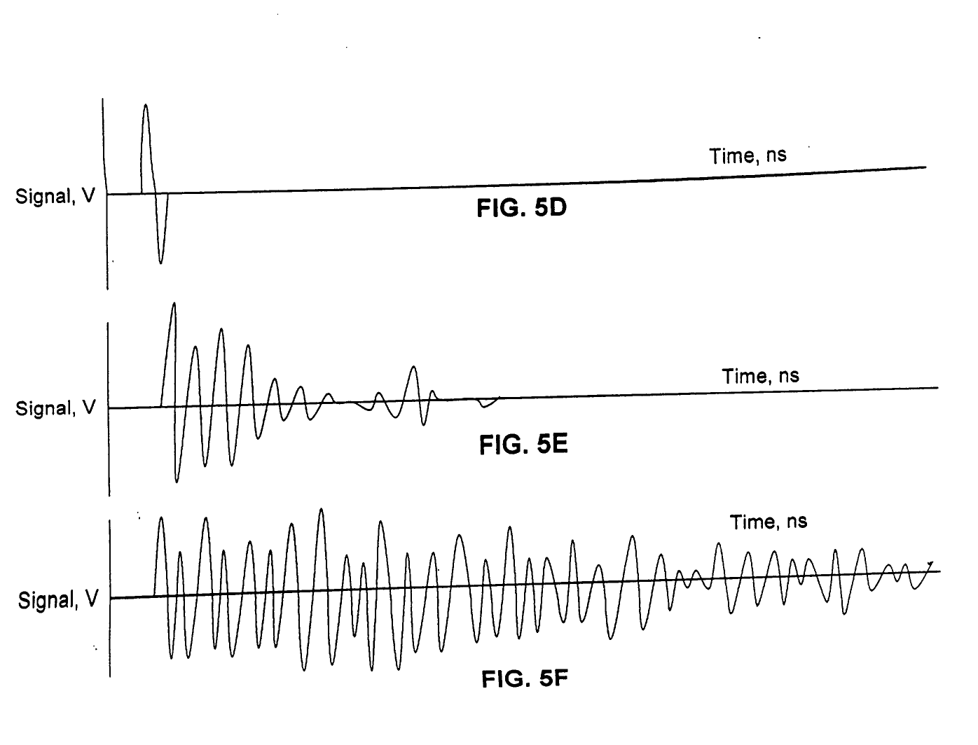

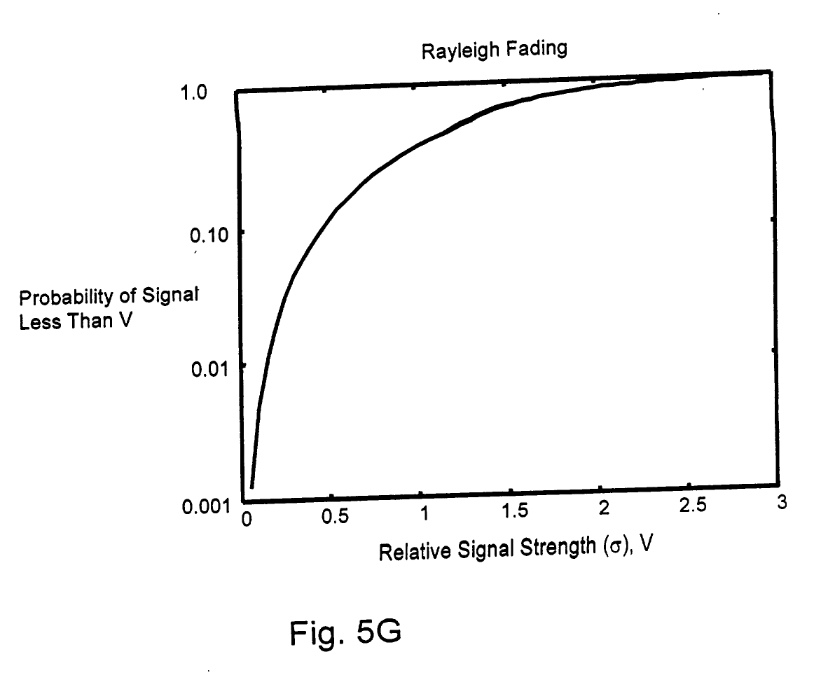

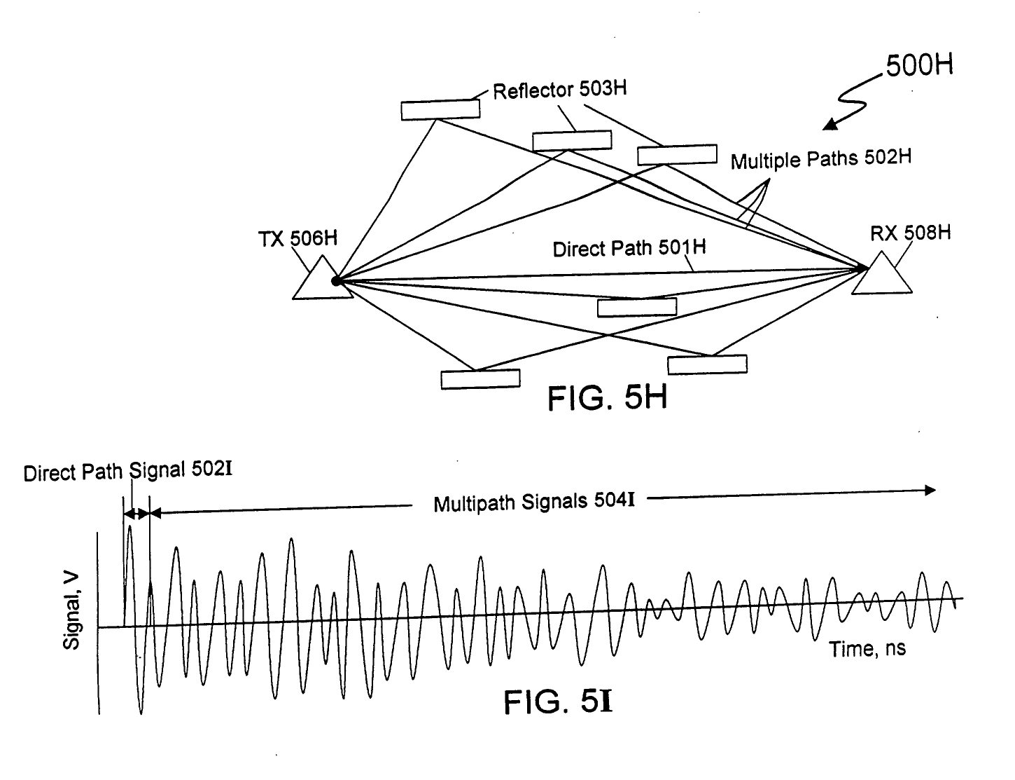

Besides providing channelization and energy smoothing, coding makes impulse radios highly resistant to interference by enabling discrimination between intended impulse transmissions and interfering transmissions. This property is desirable since impulse radio systems must share the energy spectrum with conventional radio systems and with other impulse radio systems. FIG. 5A illustrates the result of a narrow band sinusoidal interference signal 502 overlaying an impulse radio signal 504. At the impulse radio receiver, the input to the cross correlation would include the narrow band signal 502 and the received ultrawide-band impulse radio signal 504. The input is sampled by the cross correlator using a template signal 506 positioned in accordance with a code. Without coding, the cross correlation would sample the interfering signal 502 with such regularity that the interfering signals could cause interference to the impulse radio receiver. However, when the transmitted impulse signal is coded and the impulse radio receiver template signal 506 is synchronized using the identical code, the receiver samples the interfering signals non-uniformly. The samples from the interfering signal add incoherently, increasing roughly according to the square root of the number of samples integrated. The impulse radio signal samples, however, add coherently, increasing directly according to the number of samples integrated. Thus, integrating over many pulses overcomes the impact of interference.

Processing Gain

Impulse radio systems have exceptional processing gain due to their wide spreading bandwidth. For typical spread spectrum systems, the definition of processing gain, which quantifies the decrease in channel interference when wide-band communications are used, is the ratio of the bandwidth of the channel to the bit rate of the information signal. For example, a direct sequence spread spectrum system with a 10 KHz information bandwidth and a 10 MHz channel bandwidth yields a processing gain of 1000, or 30 dB. However, far greater processing gains are achieved by impulse radio systems, where the same 10 KHz information bandwidth is spread across a much greater 2 GHz channel bandwidth, resulting in a theoretical processing gain of 200,000, or 53 dB.

Capacity

It can be shown theoretically, using signal-to-noise arguments, that thousands of simultaneous channels are available to an impulse radio system as a result of its exceptional processing gain.

The average output signal-to-noise ratio of the impulse radio may be calculated for randomly selected time-hopping codes as a function of the number of active users, Nᵤ, as:

$${SNR}_{out} ( {N}_{u} ) = \frac{{( {N}_{s} {A}_{1} {m}_{p} )}^{2}}{{σ}_{rec}^{2} + {N}_{s} {σ}_{a}^{2} {\sum }_{k = 2}^{{N}_{u}} {A}_{k}^{2}}$$

where Nₛ is the number of pulses integrated per bit of information, Aₖ models the attenuation of transmitter k's signal over the propagation path to the receiver, and σ_{rec}² is the variance of the receiver noise component at the pulse train integrator output. The monocycle waveform-dependent parameters mₚ and σₐ² are given by

$${m}_{p} = {\int }_{- ∞}^{∞} ω ( t ) [ ω ( t ) - ω ( t - δ ) ] ⅆ t$$

$$and$$

$${σ}_{a}^{2} = {T}_{f}^{- 1} {\int }_{- ∞}^{∞} {[ {\int }_{- ∞}^{∞} ω ( t - s ) υ ( t ) ⅆ t ]}^{2} ⅆ s ,$$

where ω(t) is the monocycle waveform, u(t)=ω(t)−ω(t−δ) is the template signal waveform, δ is the time shift between the monocycle waveform and the template signal waveform, T_{f} is the pulse repetition time, and s is signal.

Multipath and Propagation

One of the advantages of impulse radio is its resistance to multipath fading effects. Conventional narrow band systems are subject to multipath through the Rayleigh fading process, where the signals from many delayed reflections combine at the receiver antenna according to their seemingly random relative phases resulting in possible summation or possible cancellation, depending on the specific propagation to a given location. Multipath fading effects are most adverse where a direct path signal is weak relative to multipath signals, which represents the majority of the potential coverage area of a radio system. In a mobile system, received signal strength fluctuates due to the changing mix of multipath signals that vary as its position varies relative to fixed transmitters, mobile transmitters and signal-reflecting surfaces in the environment.

Impulse radios, however, can be substantially resistant to multipath effects. Impulses arriving from delayed multipath reflections typically arrive outside of the correlation time and, thus, may be ignored. This process is described in detail with reference to FIGS. 5B and 5C. FIG. 5B illustrates a typical multipath situation, such as in a building, where there are many reflectors 504B, 505B. In this figure, a transmitter 506B transmits a signal that propagates along three paths, the direct path 501B, path 1 502B, and path2 503B, to a receiver 508B, where the multiple reflected signals are combined at the antenna. The direct path 501B, representing the straight-line distance between the transmitter and receiver, is the shortest. Path 1 502B represents a multipath reflection with a distance very close to that of the direct path. Path 2 503B represents a multipath reflection with a much longer distance. Also shown are elliptical (or, in space, ellipsoidal) traces that represent other possible locations for reflectors that would produce paths having the same distance and thus the same time delay.

FIG. 5C illustrates the received composite pulse waveform resulting from the three propagation paths 501B, 502B, and 503B shown in FIG. 5B. In this figure, the direct path signal 501B is shown as the first pulse signal received. The path 1 and path 2 signals 502B, 503B comprise the remaining multipath signals, or multipath response, as illustrated. The direct path signal is the reference signal and represents the shortest propagation time. The path 1 signal is delayed slightly and overlaps and enhances the signal strength at this delay value. The path 2 signal is delayed sufficiently that the waveform is completely separated from the direct path signal. Note that the reflected waves are reversed in polarity. If the correlator template signal is positioned such that it will sample the direct path signal, the path 2 signal will not be sampled and thus will produce no response. However, it can be seen that the path 1 signal has an effect on the reception of the direct path signal since a portion of it would also be sampled by the template signal. Generally, multipath signals delayed less than one quarter wave (one quarter wave is about 1.5 inches, or 3.5 cm at 2 GHz center frequency) may attenuate the direct path signal. This region is equivalent to the first Fresnel zone in narrow band systems. Impulse radio, however, has no further nulls in the higher Fresnel zones. This ability to avoid the highly variable attenuation from multipath gives impulse radio significant performance advantages.

FIGS. 5D, 5E, and 5F represent the received signal from a TM-UWB transmitter in three different multipath environments. These figures are approximations of typical signal plots. FIG. 5D illustrates the received signal in a very low multipath environment. This may occur in a building where the receiver antenna is in the middle of a room and is a relatively short, distance, for example, one meter, from the transmitter. This may also represent signals received from a larger distance, such as 100 meters, in an open field where there are no objects to produce reflections. In this situation, the predominant pulse is the first received pulse and the multipath reflections are too weak to be significant. FIG. 5E illustrates an intermediate multipath environment. This approximates the response from one room to the next in a building. The amplitude of the direct path signal is less than in FIG. 5D and several reflected signals are of significant amplitude. FIG. 5F approximates the response in a severe multipath environment such as propagation through many rooms, from corner to corner in a building, within a metal cargo hold of a ship, within a metal truck trailer, or within an intermodal shipping container. In this scenario, the main path signal is weaker than in FIG. 5E. In this situation, the direct path signal power is small relative to the total signal power from the reflections.

An impulse radio receiver can receive the signal and demodulate the information using either the direct path signal or any multipath signal peak having sufficient signal-to-noise ratio. Thus, the impulse radio receiver can select the strongest response from among the many arriving signals. In order for the multipath signals to cancel and produce a null at a given location, dozens of reflections would have to be cancelled simultaneously and precisely while blocking the direct path, which is a highly unlikely scenario. This time separation of mulitipath signals together with time resolution and selection by the receiver permit a type of time diversity that virtually eliminates cancellation of the signal. In a multiple correlator rake receiver, performance is further improved by collecting the signal power from multiple signal peaks for additional signal-to-noise performance.

Where the system of FIG. 5B is a narrow band system and the delays are small relative to the data bit time, the received signal is a sum of a large number of sine waves of random amplitude and phase. In the idealized limit, the resulting envelope amplitude has been shown to follow a Rayleigh probability distribution as follows:

$$p ( r ) = \frac{r}{{σ}^{2}} exp ( \frac{- {r}^{2}}{2 {σ}^{2}} )$$

where r is the envelope amplitude of the combined multipath signals. The Rayleigh distribution curve in FIG. 5G shows that 10% of the time, the signal is more than 10 dB attenuated. This suggests that 10 dB fade margin is needed to provide 90% link availability. Values of fade margin from 10 to 40 dB have been suggested for various narrow band systems, depending on the required reliability. This characteristic has been the subject of much research and can be partially improved by such techniques as antenna and frequency diversity, but these techniques result in additional complexity and cost.

In a high multipath environment such as inside homes, offices, warehouses, automobiles, trailers, shipping containers, or outside in an urban canyon or other situations where the propagation is such that the received signal is primarily scattered energy, impulse radio systems can avoid the Rayleigh fading mechanism that limits performance of narrow band systems, as illustrated in FIGS. 5H and 5I. FIG. 5H depicts an impulse radio system in a high multipath environment 500H consisting of a transmitter 506H and a receiver 508H. A transmitted signal follows a direct path 501H and reflects off reflectors 503H via multiple paths 502H. FIG. 5I illustrates the combined signal received by the receiver 508H over time with the vertical axis being signal strength in volts and the horizontal axis representing time in nanoseconds. The direct path 501H results in the direct path signal 502I while the multiple paths 502H result in multipath signals 504I. In the same manner described earlier for FIGS. 5B and 5C, the direct path signal 502I is sampled, while the multipath signals 504I are not, resulting in Rayleigh fading avoidance.

Distance Measurement and Positioning

Impulse systems can measure distances to relatively fine resolution because of the absence of ambiguous cycles in the received waveform. Narrow band systems, on the other hand, are limited to the modulation envelope and cannot easily distinguish precisely which RF cycle is associated with each data bit because the cycle-to-cycle amplitude differences are so small they are masked by link or system noise. Since an impulse radio waveform has no multi-cycle ambiguity, it is possible to determine waveform position to less than a wavelength, potentially down to the noise floor of the system. This time position measurement can be used to measure propagation delay to determine link distance to a high degree of precision. For example, 30 ps of time transfer resolution corresponds to approximately centimeter distance resolution. See, for example, U.S. Pat. No. 6,133,876, issued Oct. 17, 2000, titled “System and Method for Position Determination by Impulse Radio,” and U.S. Pat. No. 6,111,536, issued Aug. 29, 2000, titled “System and Method for Distance Measurement by Inphase and Quadrature Signals in a Radio System,” both of which are incorporated herein by reference.

In addition to the methods articulated above, impulse radio technology along with Time Division Multiple Access algorithms and Time Domain packet radios can achieve geo-positioning capabilities in a radio network. This geo-positioning method is described in co-owned, co-pending application titled “System and Method for Person or Object Position Location Utilizing Impulse Radio,” application Ser. No. 09/456,409, filed Dec. 8, 1999, and incorporated herein by reference.

Power Control

Power control systems comprise a first transceiver that transmits an impulse radio signal to a second transceiver. A power control update is calculated according to a performance measurement of the signal received at the second transceiver. The transmitter power of either transceiver, depending on the particular setup, is adjusted according to the power control update. Various performance measurements are employed to calculate a power control update, including bit error rate, signal-to-noise ratio, and received signal strength, used alone or in combination. Interference is thereby reduced, which may improve performance where multiple impulse radios are operating in close proximity and their transmissions interfere with one another. Reducing the transmitter power of each radio to a level that produces satisfactory reception increases the total number of radios that can operate in an area without saturation. Reducing transmitter power also increases transceiver efficiency.

For greater elaboration of impulse radio power control, see patent application titled “System and Method for Impulse Radio Power Control,” application Ser. No. 09/332,501, filed Jun. 14, 1999, assigned to the assignee of the present invention, and incorporated herein by reference.

Mitigating Effects of Interference

A method for mitigating interference in impulse radio systems comprises the steps of conveying the message in packets, repeating conveyance of selected packets to make up a repeat package, and conveying the repeat package a plurality of times at a repeat period greater than twice the period of occurrence of the interference. The communication may convey a message from a proximate transmitter to a distal receiver, and receive a message by a proximate receiver from a distal transmitter. In such a system, the method comprises the steps of providing interference indications by the distal receiver to the proximate transmitter, using the interference indications to determine predicted noise periods, and operating the proximate transmitter to convey the message according to at least one of the following: (1) avoiding conveying the message during noise periods, (2) conveying the message at a higher power during noise periods, (3) increasing error detection coding in the message during noise periods, (4) re-transmitting the message following noise periods, (5) avoiding conveying the message when interference is greater than a first strength, (6) conveying the message at a higher power when the interference is greater than a second strength, (7) increasing error detection coding in the message when the interference is greater than a third strength, and (8) re-transmitting a portion of the message after interference has subsided to less than a predetermined strength.

For greater elaboration of mitigating interference in impulse radio systems, see the patent application titled “Method for Mitigating Effects of Interference in Impulse Radio Communication,” application Ser. No. 09/587,033, filed Jun. 02, 1999, assigned to the assignee of the present invention, and incorporated herein by reference.

Moderating Interference in Equipment Control Applications

Yet another improvement to impulse radio includes moderating interference with impulse radio wireless control of an appliance. The control is affected by a controller remote from the appliance which transmits impulse radio digital control signals to the appliance. The control signals have a transmission power and a data rate. The method comprises the steps of establishing a maximum acceptable noise value for a parameter relating to interfering signals and a frequency range for measuring the interfering signals, measuring the parameter for the interference signals within the frequency range, and effecting an alteration of transmission of the control signals when the parameter exceeds the maximum acceptable noise value.

For greater elaboration of moderating interference while effecting impulse radio wireless control of equipment, see patent application titled “Method and Apparatus for Moderating Interference While Effecting Impulse Radio Wireless Control of Equipment,” application Ser. No. 09/586,163, filed Jun. 2, 1999, and assigned to the assignee of the present invention, and incorporated herein by reference.

Exemplary Transceiver Implementation

Transmitter

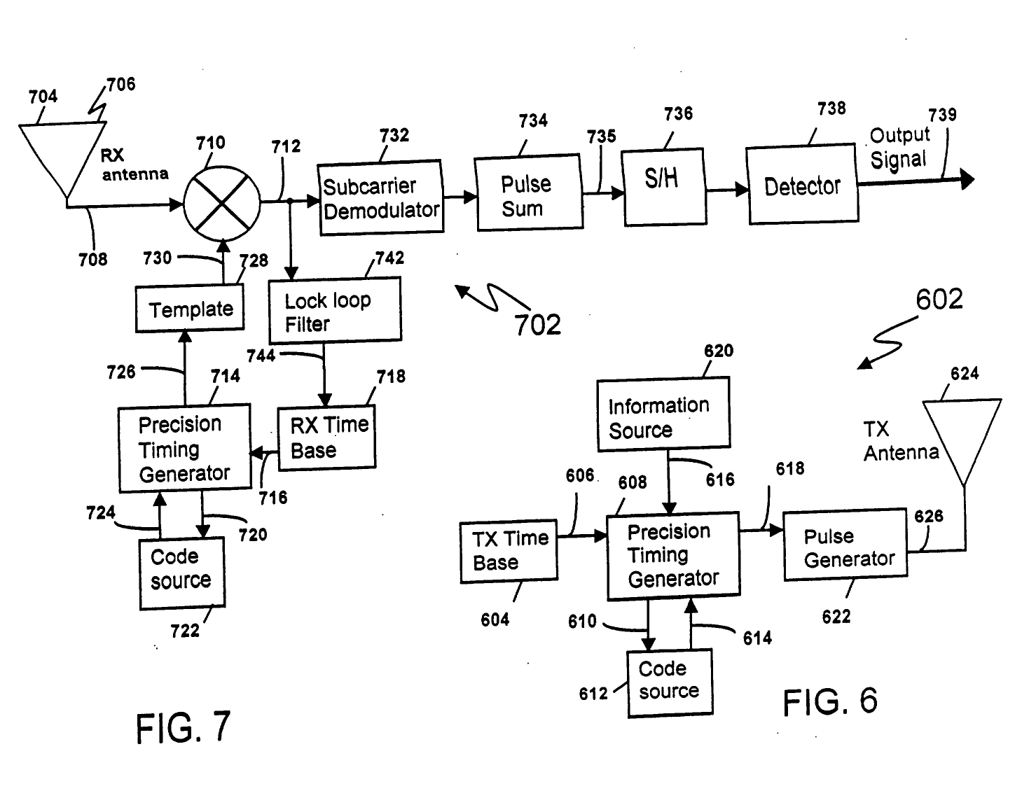

An exemplary embodiment of an impulse radio transmitter 602 of an impulse radio communication system having an optional subcarrier channel will now be described with reference to FIG. 6.

The transmitter 602 comprises a time base 604 that generates a periodic timing signal 606. The time base 604 typically comprises a voltage controlled oscillator (VCO), or the like, having a high timing accuracy and low jitter, on the order of picoseconds (ps). The control voltage to adjust the VCO center frequency is set at calibration to the desired center frequency used to define the transmitter's nominal pulse repetition rate. The periodic timing signal 606 is supplied to a precision timing generator 608.

The precision timing generator 608 supplies synchronizing signals 610 to the code source 612 and utilizes the code source output 614, together with an optional, internally generated subcarrier signal, and an information signal 616, to generate a modulated, coded timing signal 618.

An information source 620 supplies the information signal 616 to the precision timing generator 608. The information signal 616 can be any type of intelligence, including digital bits representing voice, data, imagery, or the like, analog signals, or complex signals.

A pulse generator 622 uses the modulated, coded timing signal 618 as a trigger signal to generate output pulses. The output pulses are provided to a transmit antenna 624 via a transmission line 626 coupled thereto. The output pulses are converted into propagating electromagnetic pulses by the transmit antenna 624. The electromagnetic pulses are called the emitted signal, and propagate to an impulse radio receiver 702, such as shown in FIG. 7, through a propagation medium. In a preferred embodiment, the emitted signal is wide-band or ultrawide-band, approaching a monocycle pulse as in FIG. 1B. However, the emitted signal may be spectrally modified by filtering of the pulses, which may cause them to have more zero crossings (more cycles) in the time domain, requiring the radio receiver to use a similar waveform as the template signal for efficient conversion.

Receiver

An exemplary embodiment of an impulse radio receiver (hereinafter called the receiver) for the impulse radio communication system is now described with reference to FIG. 7.

The receiver 702 comprises a receive antenna 704 for receiving a propagated impulse radio signal 706. A received signal 708 is input to a cross correlator or sampler 710, via a receiver transmission line, coupled to the receive antenna 704. The cross correlation 710 produces a baseband output 712.

The receiver 702 also includes a precision timing generator 714, which receives a periodic timing signal 716 from a receiver time base 718. This time base 718 may be adjustable and controllable in time, frequency, or phase, as required by the lock loop in order to lock on the received signal 708. The precision timing generator 714 provides synchronizing signals 720 to the code source 722 and receives a code control signal 724 from the code source 722. The precision timing generator 714 utilizes the periodic timing signal 716 and code control signal 724 to produce a coded timing signal 726. The template generator 728 is triggered by this coded timing signal 726 and produces a train of template signal pulses 730 ideally having waveforms substantially equivalent to each pulse of the received signal 708. The code for receiving a given signal is the same code utilized by the originating transmitter to generate the propagated signal. Thus, the timing of the template pulse train matches the timing of the received signal pulse train, allowing the received signal 708 to be synchronously sampled in the correlator 710. The correlator 710 preferably comprises a multiplier followed by a short term integrator to sum the multiplier product over the pulse interval.

The output of the correlator 710 is coupled to a subcarrier demodulator 732, which demodulates the subcarrier information signal from the optional subcarrier. The purpose of the optional subcarrier process, when used, is to move the information signal away from DC (zero frequency) to improve immunity to low frequency noise and offsets. The output of the subcarrier demodulator is then filtered or integrated in the pulse summation stage 734. A digital system embodiment is shown in FIG. 7. In this digital system, a sample and hold 736 samples the output 735 of the pulse summation stage 734 synchronously with the completion of the summation of a digital bit or symbol. The output of sample and hold 736 is then compared with a nominal zero (or reference) signal output in a detector stage 738 to provide an output signal 739 representing the digital state of the output voltage of sample and hold 736.

The baseband signal 712 is also input to a lowpass filter 742 (also referred to as lock loop filter 742). A control loop comprising the lowpass filter 742, time base 718, precision timing generator 714, template generator 728, and correlator 710 is used to generate an error signal 744. The error signal 744 provides adjustments to the adjustable time base 718 to position in time the periodic timing signal 726 in relation to the position of the received signal 708.

In a transceiver embodiment, substantial economy can be achieved by sharing part or all of several of the functions of the transmitter 602 and receiver 702. Some of these include the time base 718, precision timing generator 714, code source 722, antenna 704, and the like.

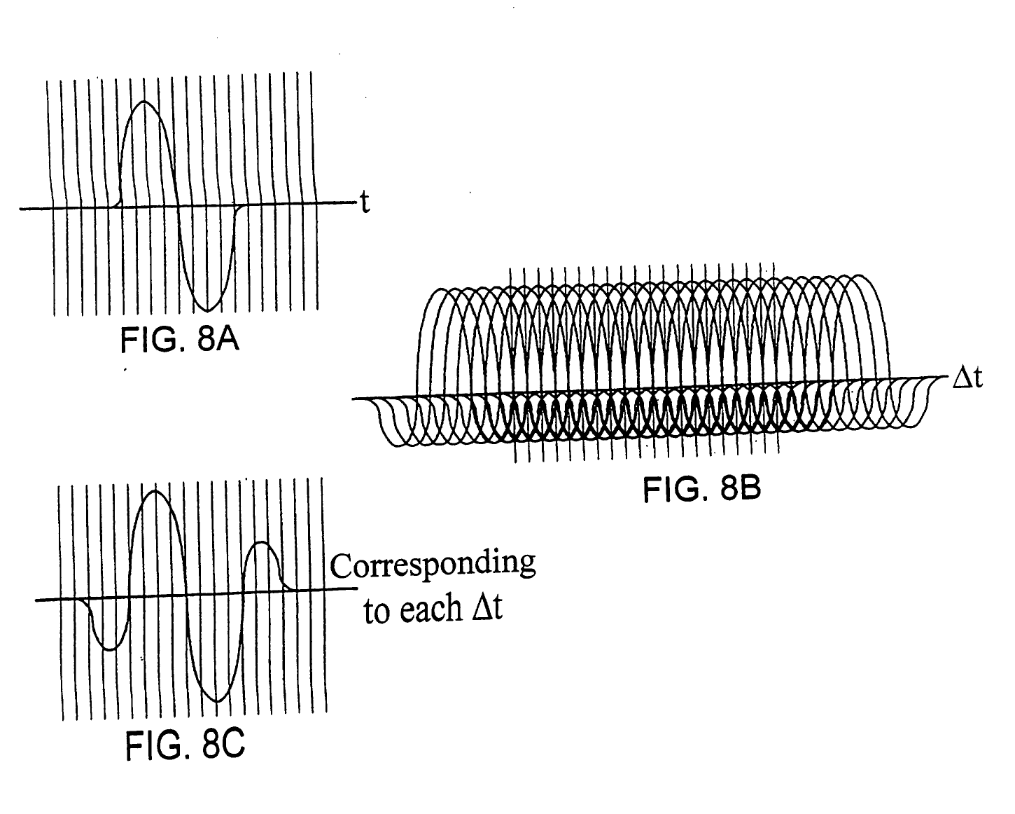

FIGS. 8A-8C illustrate the cross correlation process and the correlation function. FIG. 8A shows the waveform of a template signal. FIG. 8B shows the waveform of a received impulse radio signal at a set of several possible time offsets. FIG. 8C represents the output of the cross correlator for each of the time offsets of FIG. 8B. For any given pulse received, there is a corresponding point that is applicable on this graph. This is the point corresponding to the time offset of the template signal used to receive that pulse. Further examples and details of precision timing can be found described in U.S. Pat. No. 5,677,927, and commonly owned co-pending application application Ser. No. 09/146,524, filed Sep. 3, 1998, titled “Precision Timing Generator System and Method,” both of which are incorporated herein by reference.

Because of the unique nature of impulse radio receivers, several modifications have been recently made to enhance system capabilities. Modifications include the utilization of multiple correlators to measure the impulse response of a channel to the maximum communications range of the system and to capture information on data symbol statistics. Further, multiple correlators enable rake pulse correlation techniques, more efficient acquisition and tracking implementations, various modulation schemes, and collection of time-calibrated pictures of received waveforms. For greater elaboration of multiple correlator techniques, see patent application titled “System and Method of using Multiple Correlator Receivers in an Impulse Radio System”, application Ser. No. 09/537,264, filed Mar. 29, 2000, assigned to the assignee of the present invention, and incorporated herein by reference.

Methods to improve the speed at which a receiver can acquire and lock onto an incoming impulse radio signal have been developed. In one approach, a receiver includes an adjustable time base to output a sliding periodic timing signal having an adjustable repetition rate and a decode timing modulator to output a decode signal in response to the periodic timing signal. The impulse radio signal is cross-correlated with the decode signal to output a baseband signal. The receiver integrates T samples of the baseband signal and a threshold detector uses the integration results to detect channel coincidence. A receiver controller stops sliding the time base when channel coincidence is detected. A counter and extra count logic, coupled to the controller, are configured to increment or decrement the address counter by one or more extra counts after each T pulses is reached in order to shift the code modulo for proper phase alignment of the periodic timing signal and the received impulse radio signal. This method is described in more detail in U.S. Pat. No. 5,832,035 to Fullerton, incorporated herein by reference.

In another approach, a receiver obtains a template pulse train and a received impulse radio signal. The receiver compares the template pulse train and the received impulse radio signal. The system performs a threshold check on the comparison result. If the comparison result passes the threshold check, the system locks on the received impulse radio signal. The system may also perform a quick check, a synchronization check, and/or a command check of the impulse radio signal. For greater elaboration of this approach, see the patent application titled “Method and System for Fast Acquisition of Ultra Wideband Signals,” application Ser. No. 09/538,292, filed Mar. 29, 2000, assigned to the assignee of the present invention, and incorporated herein by reference.

A receiver has been developed that includes a baseband signal converter device and combines multiple converter circuits and an RF amplifier in a single integrated circuit package. For greater elaboration of this receiver, see the patent application titled “Baseband Signal Converter for a Wideband Impulse Radio Receiver,” application Ser. No. 09/356,384, filed Jul. 16, 1999, assigned to the assignee of the present invention, and incorporated herein by reference.

### DESCRIPTION OF THE PREFERRED EMBODIMENTS

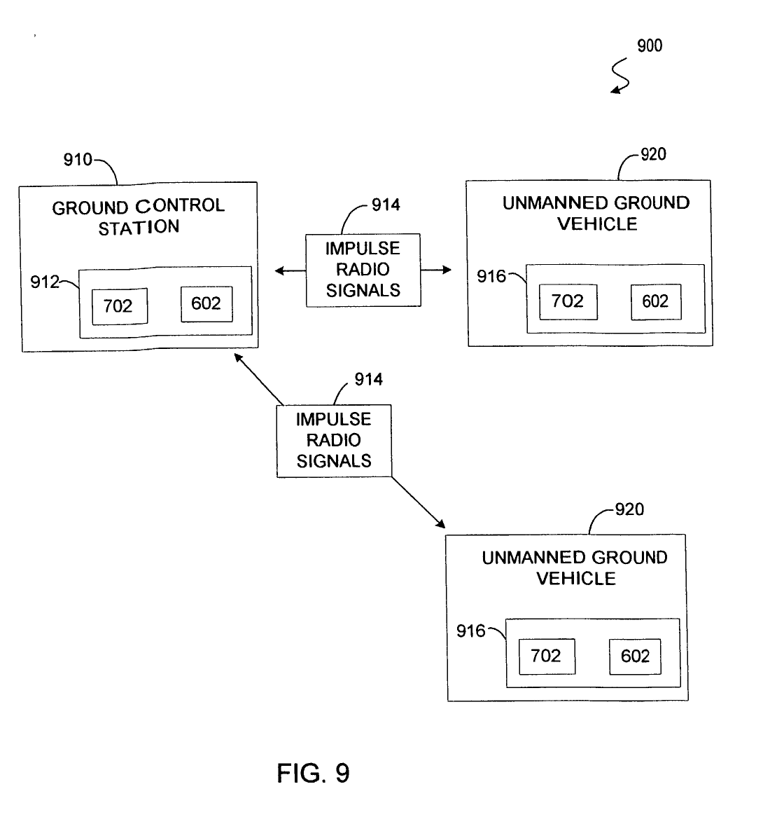

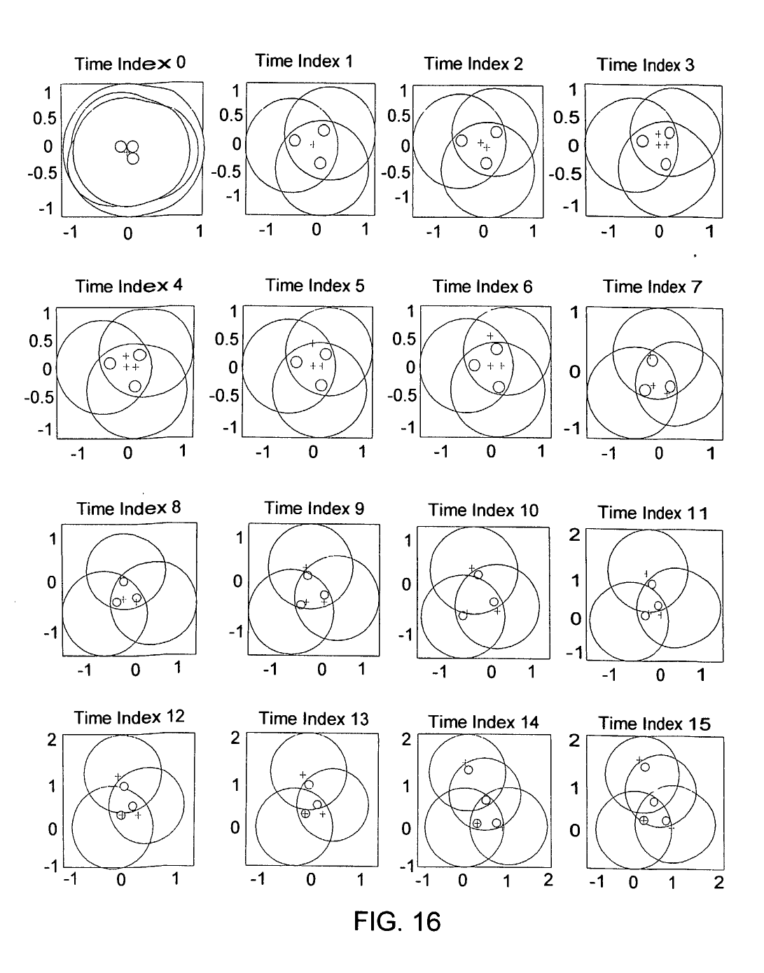

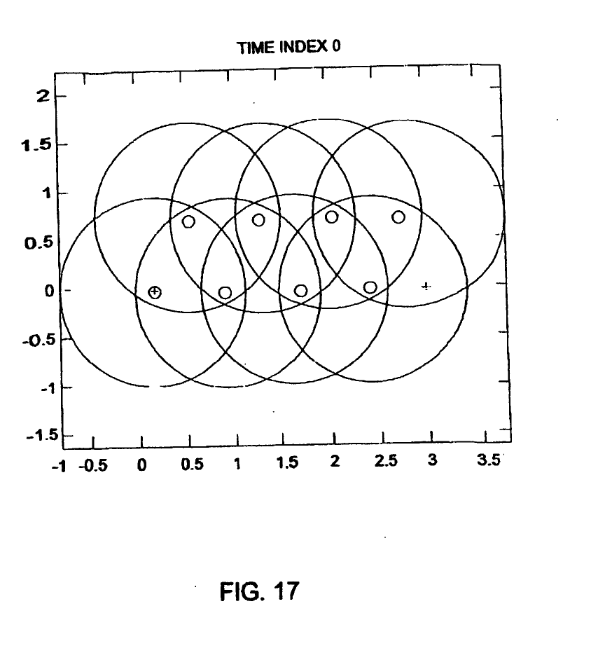

Referring to FIGS. 9-18, there are disclosed a network 900 and method 1800 in accordance with the present invention. Although the present invention is described as using time-modulated ultra wideband technology, it should be understood that the present invention can use any type of ultra wideband technology. Accordingly, the network 900 and method 1800 should not be construed in such a limited manner.

Referring to FIG. 9, there is a diagram illustrating the basic components of the network 900 in accordance with the present invention. Essentially, the network 900 includes a ground control station 910 (only one shown) and at least one unmanned ground vehicle 920 (only two shown). The ground control station 910 includes a first impulse radio unit 912 that operates to transmit and receive impulse radio signals 914 to and from second impulse radio units 916 attached to the unmanned ground vehicles 920. Each impulse radio unit 912 and 916 can be configured as a transceiver and include a receiving impulse radio unit 602 and a transmitting impulse radio unit 702 (see FIGS. 6 and 7).

Preferably, the receiving impulse radio unit 602 is configured as a scanning receiver which has two channels, one that locks onto and then tracks and external impulse radio signal. The other channel is then used to scan for other signals with the same pseudo-random time hopping and data encoding. Basically, the scanning receiver helps enable the radio, position location (described later) and radar functions of the present invention. In addition, scanning receivers enable rake pulse correlation techniques, more efficient acquisition and tracking implementations, various modulation schemes, and collection of time-calibrated pictures of received waveforms. For greater elaboration on the scanning receiver, see the patent application titled “System and Method of using Multiple Correlator Receivers in an Impulse Radio System”, application Ser. No. 09/537,264, filed Mar. 29, 2000, assigned to the assignee of the present invention, and incorporated herein by reference.

Again, the ground control station 910 is capable of transmitting and receiving impulse radio signals 914 to and from the unmanned ground vehicles 920. In particular, the impulse radio signals 914 can convey information using a known pseudorandom sequence of pulses that look like a series of Gaussian waveforms (see FIGS. 1-3). As described above, the use of impulse radio signals 914 enables secure communications to occur between the ground control station 910 and the unmanned ground vehicle 920. Essentially, the ground control station 910 and unmanned ground vehicles 920 can use impulse radio signals 914 to transmit and receive information to and from one another in places and situations not possible with traditional communication systems. In fact, both the ground control vehicle 910 and unmanned ground vehicles 920 can incorporate one chip that enables the revolutionary and highly scalable communication capabilities, radar capabilities and position capabilities of impulse radio technology.

Traditional communication systems used to transmit and receive radio signals between a traditional transmitter and traditional receiver often suffer from the adverse affects of “dead zones” and “multipath interference”. Dead zones in an urban area or forest make it difficult for a ground control station to enable communications with an unmanned ground vehicle using standard radio signals. For instance, the standard radio signals sent from the standard radio transceiver attached to the ground control station may not be able to penetrate a certain building, tree or hill and as such may not reach the standard radio transceiver attached to an unmanned ground vehicle. Fortunately in the present invention, the impulse radio signals 914 transmitted between the ground control station 910 and unmanned ground vehicles 920 are not as attenuated by buildings, trees, hills etc . . . as compared to standard radio signals.

“Multipath interference” which can be very problematic for traditional telecommunication systems within an urban area (for example) can be caused by the interference of a standard radio signal that has reached a traditional receiver by two or more paths. Essentially, a standard radio receiver attached to an unmanned ground vehicle may not be able to demodulate a radio signal because the originally transmitted radio signal effectively cancels itself out by bouncing off a building (for example) before reaching the unmanned ground vehicle and vice versa. The present invention is not adversely affected by “multipath interference” because the impulses of the impulse radio signals 914 delayed by multipath reflections typically arrive outside a correlation (or demodulation) period of the receiving impulse radio unit.

As described above, traditional wireless communication technologies suffer from a variety of undesirable characteristics including (for example):

A limited spectral bandwidth.

A shared broadcast medium.

Being unprotected from outside signals.

In contrast, the use of impulse radio technology in the present invention provides many advantages over traditional wireless communication technologies including, for example, the following:

Ultra-short duration pulses which yield ultrawide bandwidth signals.

Extremely low power spectral densities.

Excellent immunity to interference from other radio systems.

Significantly reduced power consumption over conventional radios.

High bandwidth and multi-channel performance.

Furthermore, communications have always been of critical value to successful military operations. The 20^{th} Century introduction of radio and radar systems revolutionized the very nature of warfare. This revolution in military affairs has heightened the demand for information, security, mobility, and “real time situational awareness”. To address this demand, advanced wireless technology is now a key component of the military art. Trends point to ever increasing requirements for mobile, secure wireless systems that can be managed effectively. Again, traditional radio technology that has matured over the past 100 years is fundamentally ill-suited for many present requirements and circumstances. Presently, the military has a number of needs that are not satisfied by traditional radio technology including (for example):

Conventional wireless communications are easily detectable.

While there are many mechanisms for encrypting communications, fundamentally narrow band and spread spectrum radios are easy to detect and target. In many cases this makes their use life and mission threatening.

Tactical communications are constrained by the absence of sufficient bandwidth.

While communication is possible at rates between a few kilo-bps and a few tens of kilo-bps, this is inadequate for modern needs.

Radio technology is expensive.

Except for the most primitive designs, most radios are not affordable and promise to remain so.

Multi-path interference minimizes performance in urban areas.

Communication is difficult and unreliable in urban areas.

Impulse radio technology represents a new insight to wireless communication and can address the aforementioned problems associated with traditional wireless communication technologies. In addition, impulse radio technology is not burdened by incompatibility with existing continuous waveform radio and the spectrum management method it entails. Thus, unique military applications such as non line-of-site applications are now possible using impulse radio technology that were not possible with the use of traditional radio systems.

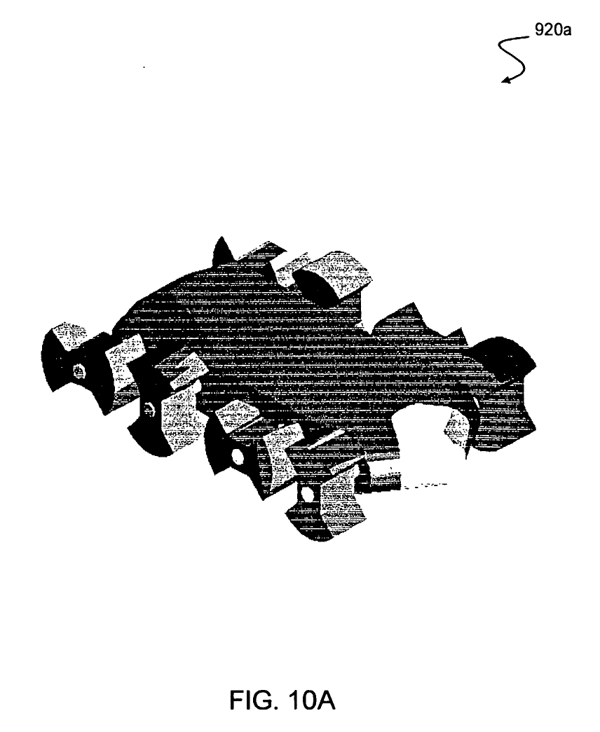

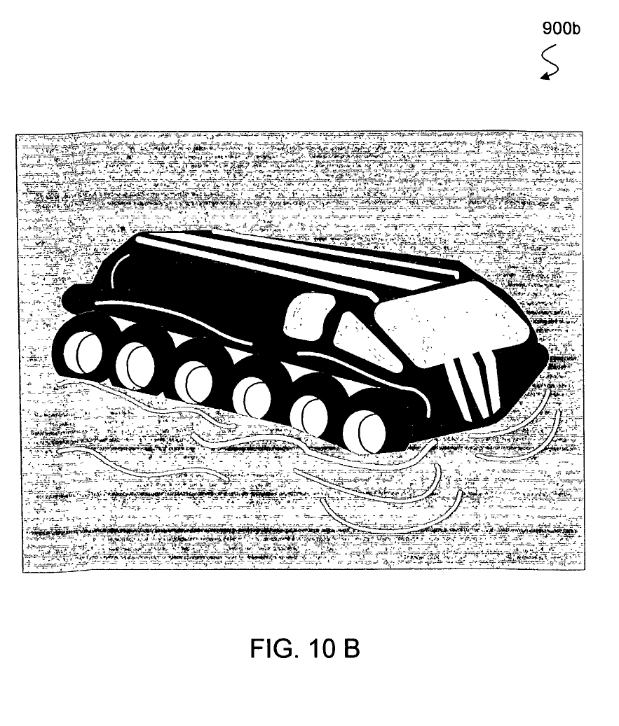

Referring to FIGS. 10A and 10B, there are illustrated diagrams of two exemplary unmanned ground vehicles 920a and 920b. Basically, the unmanned ground vehicle 920 is designed to perform a wide variety of military robot applications including its use as a sensor platform. FIG. 10A illustrates an exemplary unmanned ground vehicle 920a that is a “palm-sized” mesoscale robotic vehicle which may be used to deliver or implant a listening device or camera and may be operated by a remote individual. The unmanned ground vehicle 920a is designed to operate upside down or right side up, and is amphibious, working well in the water. In addition, the unmanned ground vehicle 920a can be optimized for law enforcement covert surveillance and SWAT type operations.

FIG. 10B illustrates an unmanned ground vehicle 920b that is larger than the “palm-sized” mesoscale robotic vehicle and has a mobility platform that enables optimal performance in multiple environments. Basically, the unmanned ground vehicle 920b can maneuver on normal roads at highway speeds, and with normal smoothness, yet has the traction equal to that of a tracked vehicle. The unmanned ground vehicle 920b can also operate in extreme conditions including on steep icy slopes, heavy snow, deep sand or mud and even water. It can also climb stairs and over debris.

As illustrated, the unmanned ground vehicle 920b has a wheel design that presents a smooth rolling surface over hard terrain yet retains a very aggressive tread. In particular, the unmanned ground vehicle 920b has 4 half-wheels on each side. In normal operation on a road, the constant radius portion of the 4 half wheels on each side of the vehicle are in contact with the road or ground. This enables the unmanned ground vehicle 920b to be stable and roll smoothly along a road. When the unmanned ground vehicle 920b begins to sink into snow, mud, or sand, traction becomes enhanced naturally as the flat portions of the wheels penetrate deeper into the ground. The degree of clawing is proportional to the degree of surface penetration. For instance, the unmanned ground vehicle 920b when operating in extreme terrain such as steep icy slopes, heavy snow, deep sand or mud can employ a “clawing” (minor phase change) or “digging” (major phase change) mode in making its way over the terrain. And, when operating on water the unmanned ground vehicle 920b can utilize an additional operating phase in which the cascaded wheels serve as paddles.

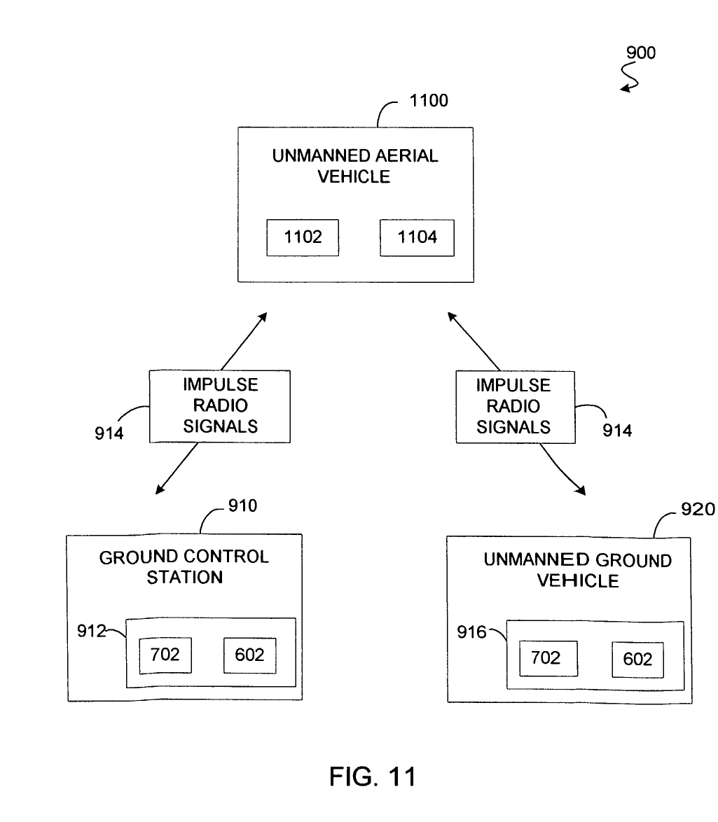

As mentioned earlier, the unmanned ground vehicle 920 can perform a wide variety of military applications including, for example, the transmission of digital video that can enable the personnel at the ground control station 910 to teleoperate the unmanned ground vehicle 920 and deliver a payload of weapons. Moreover, the unmanned ground vehicle 920 can be used for ordnance disposal, logistics re-supply and surveillance and reconnaissance operations. Other application areas include missile guidance links for low altitude trajectories, and transmission of sensor data from autonomous platforms. Preferably, the impulse radio communication range between the ground control station 910 and the unmanned ground vehicle 920 is between 10 km and 40 km, whereas current communication methods that enable a ground control station to steer the unmanned ground vehicle are limited to RF transmission of analog video over a few kilometers at most. To extend the communication range between the ground control station 910 and the unmanned ground vehicles 920, one or more unmanned aerial vehicles 1100 can be used as described below with respect to FIGS. 11-17.

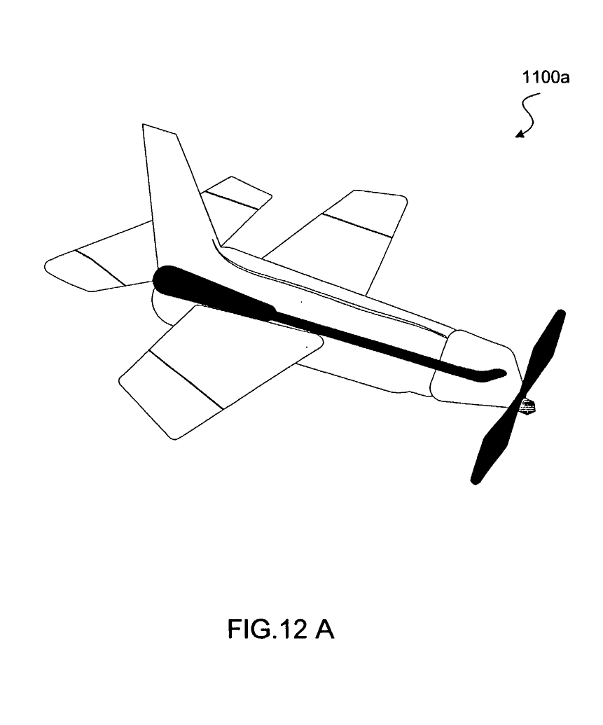

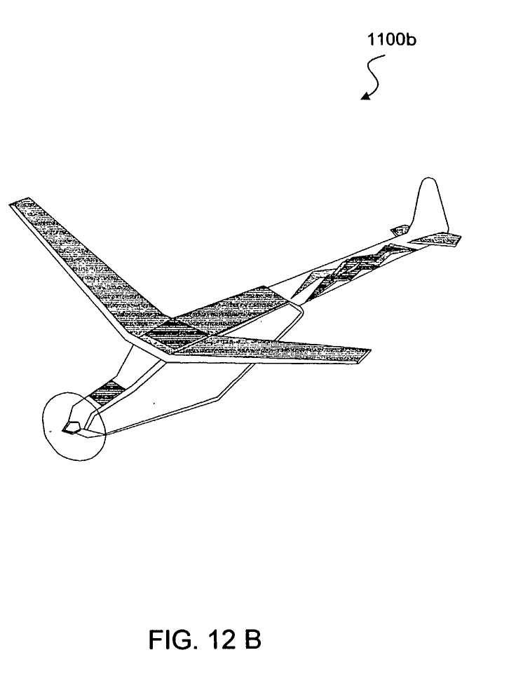

Referring to FIG. 11, there is illustrated a diagram of the network 900 that uses at least one unmanned aerial vehicle 1100 (only one shown) which acts as a repeater platform to extend the range of the impulse radio communications link 914 between each unmanned ground vehicle 920 and the ground control station 910. Each unmanned aerial vehicle 1100 also includes an impulse radio unit 1102. Because high bandwidth communication links can be disrupted by long distances between unmanned ground vehicles 920 and the ground control station 910 and can also be disrupted by large obstacles such as hills, the use of unmanned air vehicles 1100 can function as repeaters and maintain reliable communication links between the unmanned ground vehicles 920 and the ground control station 910. The use of impulse radio technology makes this feature possible. As mentioned earlier, impulse radio technology also enables an impulse radio signal 914 that has a low probability of intercept, a high resistance to jamming, and a high penetration of foliage and other small obstacles. In addition, impulse radio technology enables the unique capability that when two impulse radio units 912 and 916 communicate their relative range between one another can be calculated. FIGS. 12A and 12B illustrate two exemplary unmanned aerial vehicles 1100a and 1100b.

To maintain reliable communication links between the unmanned ground vehicles 920 and the ground control station 910, several unmanned aerial vehicles 1100 that are self-controlling and self-organizing can be used at the same time in the network 900. To be self-controlling and self-organizing means that an operator is not needed to control the flight of the unmanned aerial vehicles 1100. In other words, to be self-controlling and self-organizing means that a “swarm” of unmanned aerial vehicles 1100 can essentially control themselves so as to provide relay coverage to one or more unmanned ground vehicles 920 and one or more ground control stations 910. In particular, the self-controlling method optimizes the location of each unmanned aerial vehicle 1100 so as to provide relay coverage to the unmanned ground vehicles 920. Furthermore, the self-controlling method is capable of both identifying situations where more unmanned aerial vehicles 1100 are soon to be needed, as well as adapting the “swarm” configuration in case of sudden loss of one or more unmanned aerial vehicles (automatic repair). A main goal of the self-controlling method is that the unmanned aerial vehicles 1100 operate in a launch and forget manner. When the unmanned aerial vehicles 1100 are low in fuel they return to a base location, “pancake” to the ground, and after re-fueling and re-launch, they return to the “swarm” to continue guaranteeing high reliability, high bandwidth communication links with any number of unmanned ground vehicles 920 (limited only by the number of aircraft and channels per aircraft available). Detailed descriptions about two different ways to autonomously control a “swarm” of unmanned aerial vehicles 1100 are provided below.

In one embodiment of the self-controlling method, each of the components (e.g., unmanned ground vehicles 920, unmanned aerial vehicles 1100, ground control station 910) of the network 900 are required to perform one or more functionalities made possible by impulse radio technology such as:

The capability to determine the distance between any two unmanned aerial vehicles 1100, unmanned ground vehicles 920 and ground control stations 910 whose impulse radio units 912, 916 and 1102 are within range.

The capability to enable each unmanned aerial vehicle 1100 to determine the direction in which they are flying (some form of navigational compass). For instance, the unmanned aerial vehicles 1100 can include a compass or some navigational device 1104 to determine the direction of flight of an unmanned aerial vehicle 1100. The use of the navigation device 1104 is not only important to help guide the unmanned aerial vehicle 1100, but also to monitor the variation of a cost function with respect to the flight of that unmanned aerial vehicle 1100 (described below).

The capability to enable each unmanned aerial vehicle 1100 to fly in an approximately known trajectory (most likely a tight circle).

The capability of the unmanned aerial vehicles 1100 to travel significantly faster than the unmanned ground vehicles 920.

The capability of transmitting (possibly via other air vehicles) all or a portion of the information gathered by the unmanned aerial vehicles 1100 to a centralized location (e.g., main ground control station) for processing.

In particular, this embodiment of the self-controlling method is based on the continuous (over time) solution of two separate problems: the first problem is an asset allocation problem, where a main objective is to identify the structural constraints that the unmanned aerial vehicles 1100 need to satisfy in order to provide radio coverage to the unmanned ground vehicles 920. In other words, the self-controlling method needs to identify which unmanned aerial vehicles 1100 should be in contact with which unmanned ground vehicles 920 (i.e., within range), and which unmanned aerial vehicles 1100 should be in contact among themselves. The second problem to be solved is an optimization problem whose objective is to guide the unmanned aerial vehicles 1100 to positions that allow them to satisfy the requirements specified by the solution of the first problem. These problems are recursively solved every time period (to be indicated in the simulations by a time index) and the unmanned aerial vehicles 1100 are reconfigured accordingly. In addition to the solution of these problems, this self-controlling method can continuously evaluate the status of the current configuration, and decide whether more unmanned aerial vehicles 1100 should be launched.

To address the asset allocation problem and to maintain communication between the ground control station 910 and the unmanned ground vehicles 920, it is necessary to maintain communications between each unmanned ground vehicle 920 and at least one unmanned aerial vehicle 1100, and between the unmanned aerial vehicles 1100 themselves (although not all unmanned aerial vehicles 1100 need to be in contact among themselves). In other words, each unmanned ground vehicle 920 should have at least one unmanned aerial vehicle 1100 within range, and the unmanned aerial vehicles 1100 should be positioned in such a way as to be able them to communicate with other unmanned aerial vehicles 1100 (if needed).

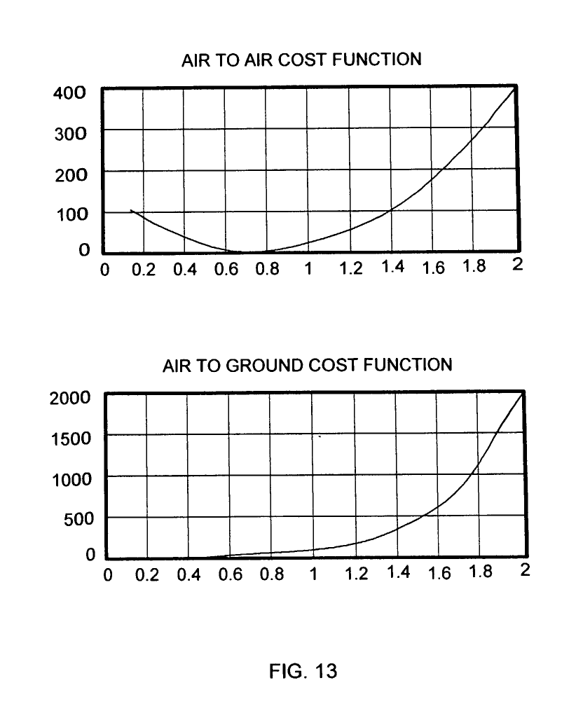

To address the optimization problem one needs to satisfy the structural requirements identified by the solution of the asset allocation problem. A minimum energy approach can be used to satisfy these structural requirements where the unmanned aerial vehicles 1100 are modeled as having “spring-like” forces between them so that an energy/cost function is related to a quadratic function of the distance between the unmanned aerial vehicles 1100. Choosing a nominal length for such a spring to be, say, 80% of the total range makes this a desirable (or low cost) distance between unmanned aerial vehicles 1100. The interaction between the ground vehicles 910 and 920 and the unmanned aerial vehicles 1100 can be modeled as a very steep cylindrical barrier centered around the position of one of the ground vehicles 910 and 920, and with a radius of about 80% of the air-to-ground transmitter/receiver range. In this manner, although the air-to-ground cost function is minimized whenever the relative distance between an air and ground vehicle is zero, there is no significant increase of this cost function unless the air vehicle approaches the boundaries of its range with respect to the ground vehicle. FIG. 13 shows a simulated example of the air-to-air and air-to-ground cost functions that can be used in the first embodiment of the self-controlling method, wherein the nominal range for these simulations is 1 unit.

It should be understood that there is preferably one ground control station 910 that is considered a centralized location where information received from the unmanned aerial vehicles 1100 is processed and stored. This is an important consideration in the case of loss of critical unmanned aerial vehicles 1100 where an unmanned aerial vehicle 1100 is considered critical if their loss implies loss of communication with one or more unmanned ground vehicles 920. In such cases, the availability of stored data regarding the lost unmanned aerial vehicle(s) 1100 and their associated unmanned ground vehicle(s) 920 is important for the replacement of the lost unmanned aerial vehicle(s) 1100.

It should also be understood that the drawings below show at least as many unmanned aerial vehicles 1100 as unmanned ground vehicles 920, but this is not a requirement and could easily be the other way around with no loss in performance.

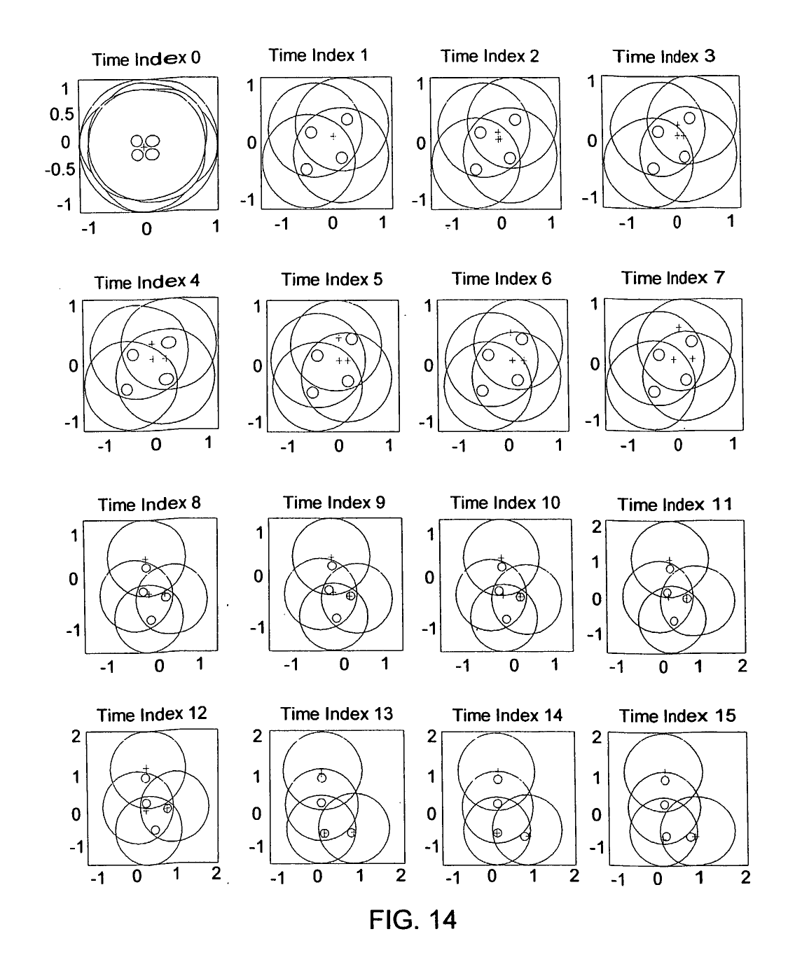

Referring to FIGS. 14-17, there are illustrated graphs of different scenarios for controlling the unmanned aerial vehicles in accordance with the first embodiment of the self-controlling method. Each of the FIGS. 14-17 represents a different scenario and each scenario is decomposed in 16 time indexes, where the increase of time indexes represents the time since the initiation of the simulation. For each time index, the status of the network 900 is represented by the location of the ground vehicles 910 and 920 (shown as a “+”) and unmanned aerial vehicles 1100 (shown as a “0”), together with the nominal radio range covered by the unmanned aerial vehicles 1100 (shown as a circle).

FIG. 14 (Scenario I) shows the results of the first simulated scenario. Two ground vehicles 920 are moving North and East of the ground control station 910 (the origin). In this scenario, four unmanned aerial vehicles 1100 are available, where one is meant to be a redundant or reserve unmanned aerial vehicle 1100. The unmanned aerial vehicles 1100 are launched at Time Index 0, and reach their nominal stations at Time Index 1 where the unmanned ground vehicles 920 have not yet started to move. Notice that the unmanned aerial vehicles 1100 have configured themselves to cover as much area as possible, while maintaining each other well within range, and also maintaining the ground vehicles 910 and 920 well within range.

By Time Index 2, the unmanned ground vehicles 920 have left the base (e.g., the ground control station 910), and are moving as planned. At this point, the unmanned aerial vehicles 1100 do not make any significant changes of position, since the network 900 does not require any adjustment. The unmanned aerial vehicles 1100 perform a significant adjustment by Time Index 8, where the unmanned ground vehicles 920 have traveled enough to warrant the movement of three of the unmanned aerial vehicles 920 almost at the same location of the unmanned ground vehicles 920, while still covering a significant amount of ground. As can be seen, the fourth unmanned aerial vehicle 920 is keeping a position close to the rest of the swarm, even though it is not really necessary.

As the unmanned ground vehicles 920 distance themselves from the ground control station 910 (e.g., base), it becomes more and more difficult for the three unmanned aerial vehicles 1100 servicing the unmanned ground vehicles 920 to remain in range. Finally, by Time Index 13 the configuration of the swarm is modified to include the fourth or redundant aerial vehicle 1100 as part of the network 900. It should be noticed that as the unmanned ground vehicles 920 keep distancing themselves from the base (Time Indexes 14 and 15), the unmanned aerial vehicles 1100 do not blindly follow them, but maintain themselves in range and in a configuration that enables the communication of all unmanned ground vehicles 920 and the ground control station 910.

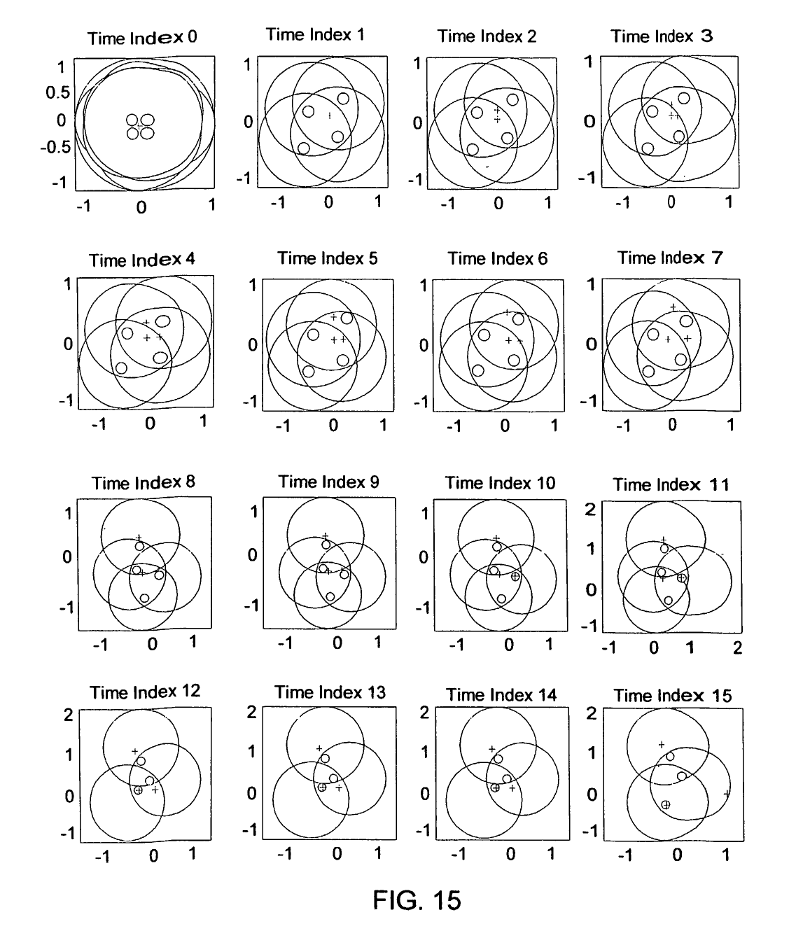

FIG. 15 (Scenario II) shows the results of the second simulated scenario. As in the previous scenario, two unmanned ground vehicles 920 are moving North and East of the base point (the ground control station 910). In this scenario, four unmanned aerial vehicles 1100 are available, where one is meant to be a redundant or reserve unmanned aerial vehicle 1100. The unmanned aerial vehicles 1100 are launched at Time Index 0, and reach their nominal stations at Time Index 1 where the unmanned ground vehicles 920 have not yet started to move.

Scenario II evolves essentially the same as Scenario I until Time Index 12. At this time, one of the unmanned aerial vehicles 1100 (the vehicle furthest north by Time Index 11) is assumed to be lost (crashed or destroyed) . As seen in Time Index 12, the remaining unmanned aerial vehicles 1100 have reconfigured by adding the fourth redundant unmanned aerial vehicle 1100 to cover for the missing one. As the second scenario continues, the remaining three unmanned aerial vehicles 1100 maintain coverage of the ground vehicles 910 and 920, without losing contact among themselves.

This scenario shows an important property of the self-controlling method: its capability to be self-healing. Once an unmanned aerial vehicle 1100 was lost at Time Index 11 no modification to the program or special case was introduced to take care of the loss of the unmanned aerial vehicle 1100. The compass and range data available is sufficient for the central processing site (e.g., ground control station 910) to know the general direction and range to the unmanned ground vehicle 920 being serviced by the lost unmanned aerial vehicle 1100. This unmanned aerial vehicle 1100 is an example of a critical unmanned aerial vehicle 1100, because its loss implies loss of communication with an unmanned ground vehicle 920.

The absolute location of the solitary unmanned ground vehicle 920 or of the unmanned aerial vehicle 1100 where communication was broken does not have to be known exactly. The redundant unmanned aerial vehicle 1100 can perform a search pattern on the area where it expects to find the unmanned ground vehicle 920 that has lost its servicing unmanned aerial vehicle 1100. The degree of sophistication and the robustness of the network 900 can be significantly improved by adding a redundant communication path to every vehicle 910, 920 and 1100.

FIG. 15 (Scenario III) shows the results of the third simulated scenario. As in the previous scenario, two unmanned ground vehicles 920 are moving North and East of the base point (the ground control station 910). In this scenario, however, only 3 unmanned aerial vehicles 1100 are launched to offer coverage, but the network 900 is allowed to deploy additional unmanned aerial vehicles 1100 as it becomes aware of such need. As in the previous two scenarios, the unmanned aerial vehicles 1100 are launched at Time Index 0, and reach their nominal stations at Time Index 1 where the unmanned ground vehicles 920 have not yet started to move. Notice that as in the previous scenarios, the unmanned aerial vehicles 1100 have configured themselves to cover as much area as possible, while maintaining each other well within range, and also maintaining the ground vehicles 910 and 920 well within range.

The overall behavior of the network 900 in this scenario is similar to that of Scenario I. The configuration of the unmanned aerial vehicles 1100 is more or less maintained until Time Index 14, where the network 900 has determined that it is beneficial to launch and deploy an additional unmanned aerial vehicle 1100. This determination is made based on the fact that at least one of the unmanned ground vehicles 920 is approaching a pre-determined percentage of the range of its servicing unmanned aerial vehicle 1100. The new unmanned aerial vehicle 1100 can be deployed in a position to link all three original unmanned aerial vehicles 1100. As mentioned earlier, the self-controlling method has the capacity to be self-healing and to make decisions regarding the deployment of additional unmanned aerial vehicles 1100.

FIG. 17 shows a network 900 having a considerably more robust configuration that has a number of advantages over scenarios I-III. In this approach, every unmanned aerial vehicle 1100 in the path between the ground control station 910 (base station) and the unmanned ground vehicle 920 (excluding the unmanned aerial vehicles 1100 at the edges) is in range of at least four other unmanned aerial vehicles 1100. Therefore, no one unmanned aerial vehicle 1100 is considered critical. In this configuration, it would take a minimum of two lost unmanned aerial vehicles 1100 to sever the communications between any two ground vehicles 910 and 920.

An additional advantage of this configuration is that the geometric arrangement makes it relatively easy to replace a fallen unmanned aerial vehicle 1100. As can be seen in FIG. 17, for any given unmanned aerial vehicle 1100, it is possible to determine its distance to at least two other unmanned aerial vehicles. Therefore, assuming a relatively constant altitude and using triangulation, all that needs to be done to replace a fallen air vehicle 1100 is to guide a new plane to whichever location results in the satisfaction of this condition. Although communications with a third unmanned aerial vehicle 1100 may be necessary to resolve ambiguities, there is always another unmanned aerial vehicle 1100 in one of the possible solutions to the geometric problem.

Finally, the proposed configuration also offers the advantage of simplifying the process of refueling the unmanned aerial vehicles 1100. Given a configuration such as that shown in FIG. 15 (for example) it would be possible to “rotate” the unmanned aerial vehicles 1100 in, say, a clock-wise direction to have them traverse all locations, forming something akin to a “chainsaw” pattern. In this fashion, an unmanned aerial vehicle 1100 would be launched, would traverse all the ground control stations 910 to and from the unmanned ground vehicle 920, and would return to base in time to be refueled and launched again.

Of course, for the unmanned aerial vehicles 1100, unmanned ground vehicles 920 and ground control station 910 to communicate with one another there is needed some sort of communication protocol. For example, there may be a low level communication protocol and a high level communication protocol. The low level communication protocol deals with how to get data between impulse radio units 912, 916 and 1102 by detailing things such as how data is encoded and transmitted, how data transmitters avoid collision on the data channel, and how the destination of the data is encoded and interpreted. For example, this can be accomplished by having a high performance Physical Layer Specification compatible with the IEEE 802.11 standard. In addition, one or more channels can be shared between the unmanned aerial vehicles 1100, unmanned ground vehicles 920 and ground control station 910.

The high level communication protocol deals with what data is required to be shared between the unmanned aerial vehicles 1100 and the unmanned ground vehicles 920 to maintain the communication network. This level is still below the level where the ground control stations 910 are actually controlling and receiving data from unmanned ground vehicles 920.

For the following discussion, the term Repeater Unit (RU) is used to designate either an unmanned aerial vehicle 1100 or unmanned ground vehicle 920, or ground control station 910. Also, for purposes of this discussion assume each Repeater Unit (RU) transmits a short message periodically on a common channel. A simple fixed slot protocol could be used on this channel. Each message transmitted by each RU would contain a Dynamic Connection Table that keeps track of which RUs (unmanned aerial vehicles 1100, unmanned ground vehicles 920 and ground control stations 910) it is in direct contact with. Assume there are 5 RUs, named A, B, C, D, and E. Assume for simplicity that A, B, C, D, and E lie along a line and that each is in contact only with its nearest neighbors.

A B C D E

Each RU builds a dynamic connection table, keeping track of which RUs it is in contact with, and repeating similar data from other communications it hears. In the simple case, D transmits that it is in direct contact with E and C, and gives the range from itself to each of those. C is not in contact with E, but it hears that D is in contact with E. When it transmits its dynamic connection data, it repeats that information (i.e. that D is in contact with E and that range). From C's transmission, B learns that D is in contact with E and that C is in contact with D. By the time A transmits, it knows the entire connection topology of the network and the relative ranges between each node from each node with which it can communicate. Similarly, every entity in the network 900 learns this information.

As an example, assume RU A is a ground vehicle and wishes to transmit data to ground station E. It only needs to look in its dynamic connection table to identify a route to E: in this case to B, to C, to D, and then to E. In many cases there will be alternative routes, but since the range of each link is also known, the best route is readily computable. The data requiring transmission in the above protocol could in the worst case grow as the square of the number of entities, but this is not a problem because the rate at which this data is needed is very slow, the data does not change rapidly, and most importantly, for most configurations much of the data does not need transmission. In this simple example, neither A nor E need to transmit anything because A is only in contact with B, and A does not have any data it has not already received from B. Likewise E only has data it has received from D and it is only in direct contact with D, so it does not need to transmit any data.

The retransmission of data, as described above, can happen simultaneously among many RUs by having the transmissions from any specific RU use a different pseudo-random code thus creating an independent channel. Another feature which gives the protocol significant flexibility is that if two radios both transmit in the same basic time window, even using the same pseudo-random sequence, the messages will not be corrupted by interference. A listening radio will correctly receive one message, and will ignore the other. This means, from a protocol standpoint, that if there are several repeaters, even if they all attempt to repeat the message, the message will still be received correctly, although not necessarily from the strongest or closest source. The protocol described above is just one type of protocol that could be used to enable communications between the unmanned aerial vehicles 1000, the unmanned ground vehicle 920 and the ground control station 910.

In another embodiment of the self-controlling method, each unmanned aerial vehicle 1100 can use impulse radio technology to calculate the location and even the direction of movement of other unmanned aerial vehicles 1100, unmanned ground vehicles 920 and ground control stations 910 that are within range. To accomplish this, the unmanned aerial vehicle 1100 includes one antenna on each wing tip and is able to measure angles of arrival directly from the time difference of arrival (TDOA) of signals received at antennas. In particular, the unmanned aerial vehicle 1100 with its wings level can obtain the azimuth angle to the unit 910, 912 or 1100 with which it is communicating. If the unmanned aerial vehicle 1100 banks 90 degrees (i.e. reorients so its wings are vertical), then that same TDOA provides the elevation angle to the unit being communicated with at that time. For a ground vehicle 910 and 920, these two values fix the position of the unit 910, 920 and 1100 with respect to the unmanned aerial vehicle 1100. For another unmanned aerial vehicle 1100 flying at an unknown altitude, either a range measurement must be made, or the first unmanned aerial vehicle 1100 must fly through a base distance in a known direction (from a compass heading) and get a second pair of readings to fix the unit's position.

There is significant value in using TDOA and the computed angle of arrival (AOA) to determine the relative position between an unmanned aerial vehicle 1100 and another unit 910, 912 or 1100. This is because to measure actual range, data is exchanged bi-directionally between the first unmanned aerial vehicle 1100 and the other unit 910, 912 or 1100 in question. This requires twice the number of channels as in the case where locations can be determined with single direction communication. For large numbers of unmanned aerial vehicles 1100 and ground vehicles 910 and 912, unidirectional communication to determine relative position would reduce the total amount of hardware required by a large factor.

Again, a purpose of the network 900 and the unmanned aerial vehicles 1100 is to establish a radio link between unmanned ground vehicles 920 and the ground control station 910. Preferably, the unmanned aerial vehicles 1100 (nodes) of network 900 are able to provide bandwidth to a ground vehicle 910 and 920. The bandwidth required may change over the mission of any unmanned ground vehicle 920, from very low, sending back periodic position data, to very high when live video images are being transmitted through the network 900. Because of the changing bandwidth requirements, the ground vehicles 910 and 920 are able to reserve a certain bandwidth for a certain period of time. Moreover, it is also possible for a higher priority task to preempt a lower priority task, even if a reservation for bandwidth has been made and accepted by the network 900.

The following is a brief summary of the second embodiment of the self-controlling method which can use a contract net paradigm for implementing a robust, flexible, and efficient wireless network 900. In the following discussion, it is assumed that each node (unmanned aerial vehicles 1100, unmanned ground vehicle 920 and ground control station 910) of the network 900 is capable of receiving and re-transmitting packets in accordance with some dynamic routing table using a consistent Datalink layer support such as MAC. Because the unmanned aerial vehicles 1100 and unmanned ground vehicles 920 are continually moving, and because unmanned aerial vehicles 1100 need to leave the swarm for refueling, the connection table is continually changing. Accurate knowledge of the connection table is important since if an unmanned ground vehicle 920 needs to send a message to an addressee, and that message is received at an unmanned aerial vehicle 1100, it must have some way to know how to route that message. This requires that particular unmanned aerial vehicle 1100 to have knowledge of what it is able to communicate with (i.e. the connection table).

A possible scheme to maintain a dynamic connection table can be based on sending out active packets or agents (also called ants) to traverse parts of the network 900 and report back the connections found. An important requirement is to maintain the connection table well enough that any incorrect information does not adversely affect the network 900, while keeping the required communication overhead to a minimum. One approach to this problem is to exploit a contract net paradigm, where decisions are made based on assigning costs and values, and positive decisions are made if the value exceeds the cost.

Nodes (unmanned aerial vehicles 1100, unmanned ground vehicles 920 and ground control stations 910) have two important parameters that they need to share with other nodes with as much resolution as feasible, given the required overhead to share that information. This information is their connectivity, and their current usage cost. Connectivity is relatively simple to encode—a node is or is not connected to another node. The cost of using a particular link is more subtle in that each node can maintain a “value function” quantifying its usage cost. This value function is non-linear and is the cost to reserve bandwidth on that link as a function of the amount of bandwidth B required and the maximum latency L that can be tolerated. This function of B and L can be adequately approximated as quadratic by using six coefficients.

When a node (unmanned aerial vehicles 1100, unmanned ground vehicles 920 and ground control stations 910) sends out an Explorer agent, each node within one hop from the first node receives that agent. They each, in turn, spawn additional identical Explorer agents, which are dispatched on each of the links leaving the one-hop nodes, to the two-hop nodes. These again spawn and dispatch additional Explorer agents to the three-hop nodes. Excellent results can be achieved by only going out three hops but more hops is definitely possible.

When Explorer agents reach the three hop nodes, they reverse direction and return along the same path back to the originating node. Each node maintains a dynamic connection table, which is updated with whatever new information is available. The returning Explorer agent combines the connection tables at each node into a composite table, updating the table at each node as applicable, and eventually arrives back at the originating node.

In addition to the basic connection table data, the returning Explorer agent also carries back the coefficients from each node that encode their cost function as defined above, giving the cost to reserve bandwidth at a given maximum latency. Nodes may use different functions because they have different hardware, or because they are designed to service different types of users. As will be described later, when these value functions are used, a negotiation occurs between an active packet arriving to establish a path transport path and the node.

Consider first the very simple network shown below. There are 5 nodes, named A, B, C, D, and E. Assume for simplicity that A, B, C, D, and E lie along a line and that each is in contact only with its nearest neighbors.

A B C D E

Each node builds a dynamic connection table, keeping track of which other nodes it is in contact with, and repeating similar data from other communication it hears. With no loss of generality, assume D transmits an Explorer agent. This agent Explorer is received by nodes E and C. E has no other link so it does not spawn an additional agent. Instead it dispatches the original agent back to D with its current cost functions, and a connection table that indicated it is in contact only with node D.

The Explorer agent received by C is dispatched by C on the link to B (or in the context of a wireless network, broadcasts the agent, which is then received only by D and B. Since D was the originator of the agent, it ignores this agent.) Node B receives the agent and dispatches it along the link to A. A is three hops far from D, so even if the network 900 were larger, the number of agents moving on the network 900 would not increase. Node A then reverses the direction of the Explorer agent and sends it back along the link to B with A's cost functions and A's current connection table data. Node B uses the returned data to update the connection table, and also stores the cost function data from A. Then B dispatches the agent back along the link to C, along with its knowledge of the connection table, and the cost functions of A and B. Continuing this, when D receives the agent back, it contains a connection table updated by all the nodes in this simple network, and all the cost functions from each node.

It should be understood that even though the Explorer agents only travel three hops (to minimize overhead), the connection table carried back will generally be a large part of the entire connection table for the entire network 900 because, in this example, nodes to the left of A would have transferred their connection tables to A previously from the movement of other Explorers. A node, therefore, will have the best information about nearby nodes (within three hops), and less current information about more distant nodes, and will have at least some information about all nodes (once the network has been operating for some time and all nodes have dispatched at least one Explorer agent).

The emergent behavior of this scheme is quite elegant. Assume a packet at node A is addressed to a distant node X. The dynamic connection table for A will have X, but that data may be old. The data for nearby nodes is more accurate. The packet is routed from link to link, along the direction of the destination, and as it approaches the destination, the connection data is more current. Heuristically this is equivalent to saying that if you are driving from Washington, D.C., to New York, N.Y., you only need to know accurately the streets near you at that moment. In Washington, you need to know the Washington streets, and in NY you need to know the NY streets. In Washington, an error in your knowledge of the NY streets will not cause significant damage, except possibly in the most pathological cases.

There is a significant overhead associated with nodes dispatching Explorer agents to return with an updated network topology and with node value functions. As such, it is beneficial to have a mechanism that optimizes this decision process to minimize this overhead, yet provide timely updates of the topology and node value functions. To accomplish this optimization, a basic contract net paradigm can be used. For example, one can use value functions and a contract net to decide when to dispatch Explorer agents from one node to its neighboring nodes within three (or possibly two) hops. There are two values of importance.

First there is the cost of dispatching that agent, which is a function of how busy the node and its neighbors are at this time. The more packets that are queued, or the higher the level of bandwidth commitments that are made, the higher the cost of dispatching the Explorer Agent. This can be computed as a function of each link, or as a single average function.

Second is the value to be gained by dispatching the Explorer. This value can be computed from a fixed function of several variables. These variables are:

The time since the last Explorer agent was dispatched, which quantifies how the age of the current information.

The velocity of this node, which quantifies how likely it is that its connectivity has changed in the time since the last update.

The change in the congestion of the node or the commitments that have been made since the last transmission. In this case, the outgoing Explorer agent would also carry data giving the nodes updated value functions.

The node compares the cost of using the link to dispatch the Explorer agent with the value obtained from doing so. If the value is positive, the agent is dispatched. If the value is negative, it is not. An immediate emergent behavior of this network is that a lightly loaded network will use the available communication bandwidth to maintain high-resolution connectivity and link cost information. As the network becomes more heavily loaded, this resolution is traded off against bandwidth.

It should be understood that the different information sharing protocols described herein can work with either of the self-controlling methods described herein.

The previous sections deal with the problem of maintaining dynamic link tables and some knowledge of the costs of using each link. They do not directly address the routing problem in which an OSI model can be used to help describe how active packets and the contract net paradigm can instantiate a transport layer that guarantees a given bandwidth and up to a maximum tolerated latency. Assume that each node has a version of the connection table, with the nearby node data more reliable than the data for distant nodes. Also assume that each node also has an approximation of the value functions of its neighboring nodes to within three hops. Furthermore, assume that a request to establish a transport layer connection for a subsequent stream of packets will have a specific bandwidth and latency specified. As such, to achieve a near optimal network layer route, with minimal network overhead, there are several steps.

First, the source node accesses its connection table to find the destination node. If it does not have the destination node in its table, then a “Search agent” is dispatched to travel to other nodes to observe their connection table until the destination node is found. Assuming the destination node is found on the local connection table, the locally stored value function parameters can be used to compute a cost to meet the specified requirement across each local link that is in the general direction of the destination. The requested bandwidth and latency are for a predetermined amount of time. At the end of that time the reserved resources are released. If the cost across one link is very high, it is dropped from further consideration.

Secondly, a “Worm agent” is then dispatched across each feasible link. The Worm agent moves from link to link in the general direction of the destination, spawning new Worm agents if two paths in the general direction of the destination appear nearly equal in cost for this particular request of bandwidth and latency. The connection table and local value functions for the nearby nodes are accessed at each node to eliminate paths which are unlikely to be the lowest cost path, and to use this more up to date connection data (than was available at the source node). Because each node has the connection data and value functions for nodes within three hops, computation needs to be done only every third hop. At each node, the cost of the route up to that point is computed. When any specific Worm reaches the destination, it has computed the total cost (sum of the “bids” at each node) along the route on which it traveled. The destination node will wait a fixed amount of time, and then reverse the direction of the lowest cost Worm, representing the lowest cost route. That Worm returns to the source using the reverse of its original route, confirming at each node a reservation of the committed bandwidth and latency allocation. It is possible that in the period between the original outbound passage of the Worm, and the return passage of the Worm, that other “bids” will have been confirmed.

The ability to renege is also important in the case where a lower priority user has obtained a commitment of bandwidth, but a higher priority requirement must be satisfied, and cannot be satisfied any other way. This all can be handled very elegantly using the contract net paradigm. There is a cost to renege. If a user request service, and has enough currency that it can pay for the desired service, plus the penalty, then the resource will be reallocated to this user. The displaced user can then itself bump a still lower priority user. To keep the network from thrashing (continually changing routings) the penalty can be set high enough that it only occurs in cases where accommodation must be made for the original requester. Note that a high penalty will also cause the requestor to use a considerably higher cost link rather than displace an already confirmed user.

As noted above, previous commitments of nodes can be overridden if the requester is willing and able to “pay” a high price, which would mean it is a high priority node that cannot achieve the transmission via a lower cost route. The key here is that the network is now self-organizing. If a link is broken, then the packets that had been using that link must find a new link. The forced rerouting may displace other lower priority nodes from using that link. The process of rerouting is performed at the network layer and transparent for the users sharing a specific transport layer. Using the currency paradigm, the entire process is self-organizing, reactive, and robust.

Continuing with the above discussion, when a node capable of forwarding packets is underutilized, it lowers its cost. This allows lower priority packets to use that link. As the link becomes more heavily utilized, it raises its price to decrease its availability to lower priority users. Lower priority users can still use the link, but they may get only lower bandwidth or higher latency because that is all they can afford. When utilization at a link reaches a high enough value, the cost will preclude use by some users, which is a necessary aspect of any system, which is guaranteeing a service level to priority users. The active packets and contract net paradigm will allow such flexibility as “low value” packets waiting to be sent whenever there is available capacity, but with no guarantee of any service.

The currency paradigm has a big advantage over the traditional RIP tables for networks. The translation of several network factors (such as latency, bandwidth and distance in hops and others) over a “currency” function can be done differently depending of the application and can be defined at runtime in the transport layer. The network layer can then be created using this flexible definition of value and routing can be established by means of active packets. Using this scheme, managing Quality of Service (QoS) is largely a matter of allocating specific amounts of “currency” to each application in each of its states. When a surveillance system (unmanned ground vehicle 920) is in watch mode but sees nothing, it may have only a small amount of currency. When a contact is made, its priority, and hence its available currency, increases, allowing it to displace other link users if necessary. Application agents always wish to use the lowest cost service, which will meet their needs. This mechanism keeps the network 900 efficient, with each packet traversing the route that provides a service to meet but not exceed its needs. An advantage of this routing method is the avoidance of network flooding by limiting the number of hoops of the active packets (ants) while being able to compose the connection tables. This approach also provides means to preempt available connections and reroute them as priority levels changes, without having to access higher layers.

Another way in which one can vary the QoS is by varying parameters of the objective function that calculates the cost of each link for a specific transport layer. Packages carrying data can also carry parameters about the transport layer from which they have been launched. This information can be passed on to the nodes themselves, which reevaluate the objective functions of the transport layer in terms of connection link costs and might dynamically reroute incoming packages.

It should be understood that to provide a dynamic network, the Global Positioning System (GPS) would provide very useful information but not enough information to enable the self-controlling methods. However, because GPS is inherently very easy to jam, even by a very unsophisticated enemy, GPS cannot be relied upon in any military scenario.

Regardless of the type of self-controlling method, active networks can be used to achieve simultaneous communications, telemetry and range determination between nodes (unmanned aerial vehicles 1100, unmanned ground vehicles 920, ground control stations 910) because of their versatility. Basically, active networking is a networking paradigm in which “active” packets in the network can carry user-specified custom code that executes on standardized “execution environments” present at the network nodes (base stations, routers, switches, hubs etc), as they traverse the network. Active packets can carry their own protocol code, which installs at the network nodes to allow the rapid introduction of innovative network protocols that tailor the network resources to an application's immediate requirements.

Using active networks, one can rapidly develop and deploy adaptive multi-rate protocols that have the ability to adapt the rate to the underlying link bandwidth and application's requirements such as the dynamic mix of communications, tracking, and telemetry at a given moment in the environment. Active networks can also be used to introduce new mobility protocols that can perform predictive hand-off, and be used to help develop protocols that can perform in-network data fusion, extensible automated device management and dynamic message re-prioritization to improve real-time performance of applications when the bandwidth decreases. Packets in the active network can be time-sensitive by allowing them to carry code that enables them to determine their importance and timeliness. In addition, packets can interact with each other in the network to implement dynamic priorities to satisfy individual Quality of Service (QoS) needs.

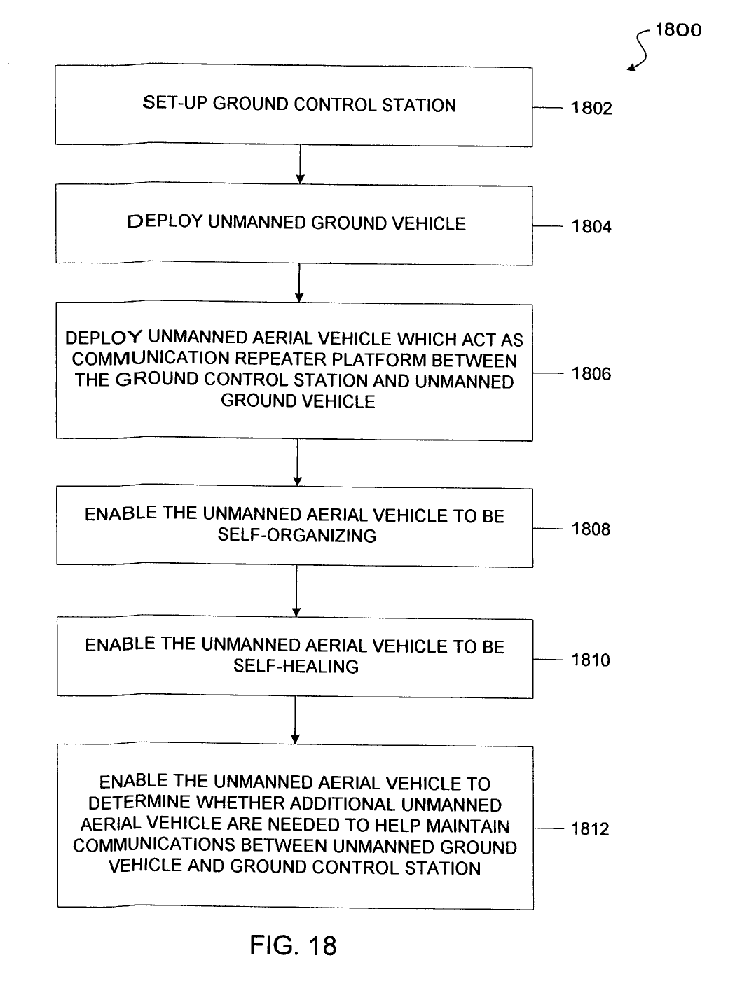

Referring to FIG. 18, there is a flowchart illustrating the basic steps of a preferred method 1800 for enabling an impulse radio communication link 914 between an unmanned ground vehicle 920 and a ground control station 910. Beginning at step 1802, one or more ground control stations 910 are set-up by military personnel. At step 1804, one or more unmanned ground vehicles 920 are deployed by the military personnel. Again, the unmanned ground vehicles 920 are designed to perform a wide variety of robot applications including its use as a sensor platform. For instance, the unmanned ground vehicles 920 can transmit a digital video that can enable the personnel at the ground control station 910 to teleoperate the unmanned ground vehicle 920. In addition, the unmanned ground vehicle 920 can be used, for example, to deliver a payload of weapons, for ordnance disposal, logistics re-supply and surveillance and reconnaissance operations. Other application areas include missile guidance links for low altitude trajectories, and transmission of sensor data from autonomous platforms.

At step 1806, one or more unmanned aerial vehicles 1100 are deployed by the military personnel. Each unmanned aerial vehicle 1100 is capable of acting as a repeater platform that extends the range of the impulse radio communications link 914 between an unmanned ground vehicle 920 and a ground control station 910. As described above and shown at step 1808, the “swarm” of unmanned aerial vehicles 1100 can be self-organizing such that a person is not required to control the movements of the unmanned aerial vehicles 1100.

The “swarm” of unmanned aerial vehicles 1100 can be self-organizing and self-healing by identifying one or more unmanned aerial vehicles 1100 that should be in communication with an unmanned ground vehicle 920. Then identifying for each of unmanned aerial vehicles 1100 which unmanned aerial vehicles 1100 they should be in communication with and guiding each unmanned aerial vehicle 1100 to a position which allows that unmanned aerial vehicle 1100 to satisfy the results of the two identifying steps.

In particular and as described above, the “swarm” of unmanned aerial vehicles 1100 can be controlled by different self-controlling methods including, for example, the self-controlling method that enables each unmanned aerial vehicle to make navigation decisions based on perceived ranges of the other unmanned aerial vehicles 1100 and the unmanned ground vehicles 920. Alternatively, another self-controlling method can enable each unmanned aerial vehicle 1100 to make navigation decisions based on perceived positions of the other unmanned aerial vehicles 1100 and the unmanned ground vehicles 920.

At step 1810, the “swarm” of unmanned aerial vehicles 1100 can be self-healing such that if one or more unmanned aerial vehicles 1100 are disabled then the remaining unmanned aerial vehicles 1100 can organize in a manner to maintain communication connectivity between the unmanned ground vehicle 920 and the ground control station 910.

Lastly, at step 1812, the “swarm” of unmanned aerial vehicles 1100 can determine whether additional unmanned aerial vehicles 1100 should be launched to help maintain communication connectivity between the unmanned ground vehicle 920 and the ground control station 910. This ability can help to maintain communications even when one or more unmanned aerial vehicles 1100 are disabled or destroyed.

Although various embodiments of the present invention have been illustrated in the accompanying Drawings and described in the foregoing Detailed Description, it should be understood that the invention is not limited to the embodiments disclosed, but is capable of numerous rearrangements, modifications and substitutions without departing from the spirit of the invention as set forth and defined by the following claims.

What is claimed is:

1. A network comprising:
a ground control station; and
at least one unmanned ground vehicle, each unmanned ground vehicle is capable of operating from a non line-of-sight location with respect to said ground control station because each unmanned ground vehicle is capable of communicating with said ground control station using an impulse radio communications link.

2. The network of claim 1, further comprising a plurality of unmanned aerial vehicles capable of acting as repeater platforms that extend a range of the impulse radio communications link between each unmanned ground vehicle and said ground control station.

3. The network of claim 2, wherein said plurality of unmanned aerial vehicles are self-controlling.

4. The network of claim 2, wherein said plurality of unmanned aerial vehicles can be self-controlling by following the steps of:
identifying one or more unmanned aerial vehicles that should be in communication with each unmanned ground vehicle;
identifying for each unmanned aerial vehicle at least one unmanned aerial vehicle they should be in communication with; and
guiding each unmanned aerial vehicle to a position which allows that unmanned aerial vehicle to satisfy the results of the two identifying steps.

5. The network of claim 2, wherein each unmanned aerial vehicle is capable of making navigation decisions based on perceived positions of other unmanned aerial vehicles and at least one unmanned ground vehicle.

6. The network of claim 2, wherein each unmanned aerial vehicle is capable of making navigation decisions based on perceived ranges of other unmanned aerial vehicles and at least one unmanned ground vehicle.

7. The network of claim 2, wherein said plurality of unmanned aerial vehicles are self-healing such that if one or more unmanned aerial vehicles become disabled then the remaining unmanned aerial vehicles can organize in a manner to maintain communication connectivity between each unmanned ground vehicle and said ground control station.

8. The network of claim 2, wherein said plurality of unmanned aerial vehicles are capable of determining whether additional unmanned aerial vehicles should be launched to help maintain communication connectivity between each unmanned ground vehicle and said ground control station.

9. The network of claim 1, wherein said network is an active network capable of adjusting the bandwidth of each impulse radio communications link.

10. A method for enabling an impulse radio communication link between an unmanned ground vehicle and a ground control station, said method comprising the steps of:
setting up the ground control station;
deploying the unmanned ground vehicle; and
deploying a plurality of unmanned aerial vehicles each of which is capable of acting as a repeater platform that extends a range of the impulse radio communications link between the unmanned ground vehicle and the ground control station.

11. The method of claim 10, wherein said step of deploying a plurality of unmanned aerial vehicles in a manner such that the unmanned aerial vehicles are self-controlling.

12. The method of claim 10, wherein said plurality of unmanned aerial vehicles can be self-controlling by following the steps of:
identifying one or more unmanned aerial vehicles that should be in communication with the unmanned ground vehicle;
identifying for each unmanned aerial vehicle at least one unmanned aerial vehicle they should be in communication with; and
guiding each unmanned aerial vehicle to a position which allows that unmanned aerial vehicle to satisfy the results of the two identifying steps.

13. The method of claim 10, wherein said step of deploying a plurality of unmanned aerial vehicles further includes the step of enabling each unmanned aerial vehicle to make navigation decisions based on perceived positions of other unmanned aerial vehicles and said unmanned ground vehicle.

14. The method of claim 10, wherein said step of deploying a plurality of unmanned aerial vehicles further includes the step of enabling each unmanned aerial vehicle to make navigation decisions based on perceived ranges of other unmanned aerial vehicles and said unmanned ground vehicle.

15. The method of claim 10, wherein said step of deploying a plurality of unmanned aerial vehicles further includes the step of enabling said plurality of unmanned aerial vehicles to be self-healing such that if one or more unmanned aerial vehicles become disabled then the remaining unmanned aerial vehicles can organize in a manner to maintain communication connectivity between said unmanned ground vehicle and said ground control station.

16. The method of claim 10, wherein said step of deploying a plurality of unmanned aerial vehicles further includes the step of enabling said plurality of unmanned aerial vehicles to determine whether additional unmanned aerial vehicles should be launched to help maintain communication connectivity between said unmanned ground vehicle and said ground control station.

17. The method of claim 10, wherein said impulse radio communications link is capable of simultaneously supporting communications, telemetry and range determinations.

18. An unmanned aerial vehicle comprising:
an impulse radio unit capable of enabling an impulse radio communications link between an unmanned ground vehicle and a ground control station, wherein said unmanned ground vehicle is operating from a non line-of-sight location with respect to the ground control station.

19. The unmanned aerial vehicle of claim 18, wherein said unmanned aerial vehicle is part of a swarm of unmanned aerial vehicles that are self-controlling.

20. The unmanned aerial vehicle of claim 19, wherein each unmanned aerial vehicle in the swarm of unmanned aerial vehicles is capable of making navigation decisions based on a perceived position of the unmanned ground vehicle.

21. The unmanned aerial vehicle of claim 20, further comprising a pair of ultra-wideband antennas each of which receives an impulse radio signal from the unmanned ground vehicle which enables said unmanned aerial vehicle to determine a time difference of arrival measurement and then an angle of arrival measurement which indicates the position of the unmanned ground vehicle.

22. The unmanned aerial vehicle of claim 19, wherein each unmanned aerial vehicle in the swarm of unmanned aerial vehicles is capable of making navigation decisions based on a perceived range of the unmanned ground vehicle.

23. The unmanned aerial vehicle of claim 18, wherein said unmanned aerial vehicle is part of a swarm of unmanned aerial vehicles that are self-healing such that if one or more unmanned aerial vehicles become disabled then the remaining unmanned aerial vehicles can organize in a manner to maintain communication connectivity between the unmanned ground vehicle and the ground control station.

24. The unmanned aerial vehicle of claim 18, wherein said unmanned aerial vehicle is part of a swarm of unmanned aerial vehicles that are capable of determining whether additional unmanned aerial vehicles should be launched to help maintain communication connectivity between the unmanned ground vehicle and said ground control station.

25. An unmanned ground vehicle comprising:
an impulse radio unit capable of communicating with an ground control station using an impulse radio communications link, wherein a range of said impulse radio communications link can be extended by using unmanned aerial vehicles as repeater platforms between the ground control station and said unmanned ground vehicle.

26. The unmanned ground control vehicle of claim 25, wherein said unmanned ground control vehicle is capable of operating from a non line-of-sight location with respect to the ground control station.

27. The unmanned ground vehicle of claim 25, further comprising at least one sensor coupled to said impulse radio unit that is capable of transmitting sensor related data to the ground control station.

28. The unmanned ground vehicle of claim 25, further comprising a camera coupled to said impulse radio unit that is capable of transmitting a digital video to the ground control station.

29. The unmanned ground vehicle of claim 25, wherein said impulse radio communications link is enabled by a high level information sharing protocol.
